(19) United States
(12) Patent Application Publication
(10) Pub. No.: US 2015/0095205 A1
(43) Pub. Date: Apr. 2, 2015

(54) SYSTEM AND METHOD FOR EXTRACTION AND ACTIONABLE ANALYSIS OF DIGITAL RECEIPTS AND TRANSACTION LOGS

(71) Applicant: iState Inc., Winslow, AZ (US)

(72) Inventors: William Logan Hebner, Springdale, UT (US); Richard Halter, Mustang, OK (US); Daniel Wiercioch, Santa Ana, CA (US); Allan Affeldt, Winslow, AZ (US)

(21) Appl. No.: 14/503,124

(22) Filed: Sep. 30, 2014

Related U.S. Application Data
(60) Provisional application No. 61/884,937, filed on Sep. 30, 2013.

(51) Int. Cl. G06Q 40/00; G06Q 20/10

(52) U.S. Cl. CPC G06Q 40/123; G06Q 20/10
USPC 705/31

(57) ABSTRACT

Embodiments of the invention provide a sales and use tax analysis and reconciling system that includes an item and ontology restriction interface, an item and ontology restriction engine, a sales and use tax application program interface, a sales and use tax engine, a sales and use tax accounting engine, and an item and ontology restriction engine. The item and ontology restriction interface can receive point of sale transaction data and process a transaction message, and the item and ontology restriction engine can transmit the transaction message to an item and ontology restriction analysis engine for analysis. The sales and use tax application program can transmit totaled transaction data. From this data, a sales and use tax engine can create fund split and electronic fund transfer instructions for an acquirer gateway, and the sales and use tax can be reconciled and sent to a funding source.

### RELATED APPLICATIONS

This application claims priority from Provisional Application No. 61/884,937, filed on Sep. 30, 2013, the entire contents of which are incorporated herein by reference.

### BACKGROUND

Presently, credit/debit and electronic benefit (hereinafter referred to as “EBT”) card transactions perform the basic functions of checking the customer's bank account against a pending charge, to either approve or deny a given transaction on the basis of the availability of said funds. The two-way Automated Clearing House (hereinafter referred to as “ACH”) data stream carries the proposed transaction amount to the customer's bank, checks the amount against the customer's available funds, and then returns to the merchant point of sale system (wherein point of sale is hereinafter referred to as “POS”) with a subsequent approval or denial. If the transaction is approved, the money transfers via an acquirer from the customer's account to the merchant's bank, and the customer gets the goods and a printed or digital receipt. However, prior to, during and after this basic transaction, all parties to the transaction including the customer, merchant, states (for sales and use taxes), and federal government (if federal program spending is involved), perform diverse, time consuming, expensive, and critical functions preparing for, executing, analyzing, and subsequently accounting for this transaction.

Prior to any transactions, merchants wishing to participate in government programs such as the “Special Supplemental Nutrition Program for Women, Infants, and Children” (hereinafter referred to as “WIC”) must manually enter authorized inventory into their inventory POS system, which then must be periodically updated. Merchants offering Medicare services require special POS systems capable of downloading monthly, frequently changing SIGIS lists from the IRS. Merchants wishing to participate in the Supplemental Nutrition Assistance Program (hereinafter referred to as “SNAP”) must train their clerks to be able to police SNAP transactions, whose parameters are also susceptible to change.

During transactions, merchant POS machines calculate approximate sales taxes, add that tax amount to the transaction, and subsequently charge the customer for the total amount of goods plus approximated taxes. Oftentimes, these taxes can change, both by percentage and category, requiring the merchant to monitor such changes. Also during transactions, associates must enforce SNAP and WIC transactions to assure that only authorized items are being purchased.

A majority of the transaction processing work occurs after the transaction has occurred. Any number of government programs, corporations, private industry finance services (such as “teen cards”), emergency relief services (such as the American Red Cross), etc., can all have defined parameters or authorized or restricted item lists. At present, all such transactions can only be monitored and vetted after the transaction has been completed, leaving all such programs open to misuse and fraud. This inability to preside over POS transactions in real-time requires that both private sector and government programs must maintain any number of expensive, time consuming, peripheral systems surrounding said transactions. These systems are typically designed to prepare for, monitor, control, assess, and subsequently account for a given transaction. These systems must operate outside the transaction itself, mostly after-the-fact, with limited success in practice.

The merchant must also periodically account for and pay sales and use taxes (herein referred to as “SUT”). They must justify the amount they've collected against the actual taxes owed. Then they must mail the return amount to the central taxing jurisdiction (usually the state) which then must manually open these tax returns, deposit these funds, enter those data into the respective merchant accounts, and then re-distribute these funds back to the appropriate local tax authority, such as counties and municipalities. Finally, transaction information for all these government and private sector programs must be manually entered into the respective accounting programs to become available for use, analysis, reports and accounting.

Prior art systems, patents and applications exist in the art that purport to vet card purchases on an item level basis. The crux issue here is how they claim to identify specific items and relevant item ontology. These systems in fact do not perform these key identification functions from the merchant's proprietary inventory system data. Some such systems restrict their claims to health care items, where these program items, such as pharmaceuticals, all share a universal product codes (hereafter “UPC's”), thus eliminating the need for the third party to run item identification analytics. Other systems for online purchase accounting contemplate the merchant will simply share, and then continually update, their inventory codes with the third party in order to benefit from the third party's invention.

What is needed is a system, method, and technology to monitor and control POS transactions, on an item or ontology level as needed, in “real-time,” and a system and method both supported and informed by this real-time capacity. Such a source controlled finance system (hereafter “SCF”) and method could send, prior to tender phase, proposed transactions to a central database, and analyze transaction data to identify specific items or item ontology as needed. The system could then match these identities to the applicable program database, enabling the system to render a judgment either approving, denying, or offering to modify a given transaction based on said program parameters.

Nearly all retail transactions are subject to sales or use taxes. In general, a sales tax is due when a transaction occurs with the buyer and retailer at the same physical location or in the same state, such as a retail store. Sales taxes are added to the “Subtotal Transaction” and collected by the retailer for remittance to the state at some future date. In general, a use tax is due if a transaction crosses state lines, typically when a buyer purchases goods (e.g., by purchasing online or by phone) that will be shipped from another state. Because of sales tax differences among the states and municipalities, use taxes are generally not collected by retailers, but instead are the responsibility of the buyer, and are taxed at the buyer's local rate, and referred to as destination-based sales tax.

There are many problems with the collection of sales and use taxes (hereafter “SUT”). Some retailers collect the tax, spend it, and then go out of business. Some retailers collect the tax but underreport their sales and keep the difference. Some retailers never register with the states, do not collect sales tax or collect it, and do not remit to the states. Further, online transactions are assumed to be tax-free when in fact virtually none are; buyers are supposed to report such transactions and send in the use taxes due. All of these transactions share the problems of self-reporting: retailers and buyers are expected to honestly and timely record and report all of their sales and purchases, and to remit the appropriate sales and use taxes to all of the appropriate tax authorities.

There are many patents dealing with online tax analysis. And there are many patents dealing with sales tax collection. But there is no system or technology that enables states and municipalities or their proxies to monitor transactions, verify actual totals, and collect appropriate SUT on any time horizon, let alone in real-time. In the U.S. the problem is compounded by various legal rulings; in particular the Quill Decision of the U.S. Supreme Court (Quill Corp. v. North Dakota, 1992). Quill invokes the interstate commerce clause to prohibit states from requiring online retailers to collect sales taxes unless they can prove it is not an undue burden on the retailers (a stumbling block to collecting such taxes). Since online sales are an ever-increasing percentage of the retail economy, the states have no way to collect an ever-increasing percentage of use taxes. In response to this costly dilemma, a majority of states have joined or are working with the “Streamlined Sales Tax Project” to seek a solution. The best they have been able to come up with after ten years effort is for the states to try and negotiate so called ‘Amazon Taxes’, whereby each state must seek (on a merchant-by-merchant, state-by-state basis) negotiated agreements to collect SUT. Even this highly complicated and uncertain process completely ignores the problem of self-reporting, and results in highly uneven collections.

How big is this problem? The IRS estimates the “Income Tax Gap” (the difference between what is legally due and what is actually paid) to be at 17%. Income tax due on wages is collected automatically by employers. Stock and investment income is reported automatically by brokerage houses and highly regulated. SUT in contrast is entirely self-reported so the SUT gap is likely much higher than the 17% Income Tax Gap. Many reports suggest that the failure to remit use tax exceeds 50% (i.e., SUT is probably not collected on a majority of online sales).

Retail transactions are not directly reported to sales tax authorities; at best, the states get a summary of sales, self-reported by each retailer, typically on a monthly basis. The reports are often hand-written, and must be entered one at a time by the appropriate state agency. The only thorough study of SUT gap was by the Minnesota Department of Revenue. They estimated a SUT gap of 12.2% in 2002, rising to 13.4% in 2011 as online sales increased. Moreover, this does not include the so-called “shadow economy”, where unreported and untaxed transactions is estimated by the World Bank to be 8.8% of total U.S. transactions in 2007. Gross reported retail sales in the United States were roughly $375 billion in 2012. If the SUT gap is only 10% (and not even considering shadow economy transactions) then the loss to states and municipalities in 2012 from legally due but uncollected sales and use taxes was at least $37 billion.

Systems, patents and applications also exist in the art that state they can analyze and calculate sales tax for transactions in “real-time,” however, they only claim to work with online transactions. Many such patents were engendered by the “Streamlined Sales Tax movement” beginning in 1999, based on the probability that states would soon be able to collect sales taxes for online purchases. However, “real-time” prior to about 2006 had qualitatively different meaning, as speeds for collecting, transmitting, and analyzing data matched acceptable latencies only for online sales, up to forty seconds. Presently, patents and applications in the art claim the ability to perform these tasks, but only for online services, or for credit/debit EBT card transactions. They propose to provide third party service to merchandisers which calculate applicable taxes, and collect applicable taxes (usually by access to the merchant's bank account) to distribute to a central taxing authority, usually the state, on a periodic basis for future distribution to local taxing jurisdictions such as counties and municipalities. However, these systems and methods still leave cash transactions unaccounted for, so the merchant must still expend time and money for tax accounting and reporting. Moreover, these systems do not distribute the tax dollars to the appropriate local jurisdictions, costing the states additional time and money.

The definition of “real-time” has qualitatively shortened with ability of “Big Data” to instantaneously analyze large quantities of data, together with the exponentially increased capacity to store and transmit said data. This began around 2005-2006, as storage costs dropped with the inception of cloud computing and storage, and the innovation of new techniques, such as parallelism on blade servers, algorithms for processing massive amounts of distributed data, analytic processing methods such as MapReduce and Apache Hadoop, increased bandwidth, critical advances in POS technology, and shared standards, combining to create consistencies throughout various systems. All this synergized to vastly increase the amount of data available for analysis while exponentially reducing processing and transmission time.

In 2005, 130 exabytes of data were created and stored. In 2011, well over a zettabyte of data was created. The explosion in data storage was facilitated by and development of cloud storage systems in 2006. Storage costs dropped, fueling data storage growth. Storage costs have fallen from USD $18.9/gigabyte in 2005 to USD 1.6/gigabyte in 2011, and are expected to further decline to USD $0.07/gigabyte by 2015. In 2005, parallel computing began to arrive on the personal computer scene via dual-core chips.

Multi-core processors, which enable parallel computing, feature two or more independent central processing units, and can run multiple instructions at the same time, decreasing the amount of time it takes to complete certain classes of parallel tasks. MapReduce and Hadoop took advantage of parallel computing to process distributed data quickly and effectively, with a high degree of system availability. MapReduce, a programming model for processing and generating large data sets, was first outlined by Google in December of 2004. Google and the Google logo are registered trademarks of Google Inc. MapReduce functions as a type of parallelism and runs on a large cluster of commodity machines and is highly scalable. A typical MapReduce computation processes many terabytes of data on thousands of machines, with multiple iterations. In August 2013, the open-source software framework Apache Hadoop beta version was released. Hadoop, which implements MapReduce, is becoming one of the standards for Big Data. Hadoop allows tasks to be distributed across large numbers of coordinated compute nodes' and is designed to scale up from single servers to thousands of machines, each offering local computation and storage. Further, the system functions like a multi-core computer with many cores in many locations. It can run on a large number of machines which do not share memory or disks. Moreover, it enables huge volumes of data to be stored and rapidly accessed across large clusters of servers. For instance, in July 2013, Yahoo, Inc. claimed to have set a record in May of 2013 by using Hadoop to sort data at a rate of 1.42 terabytes per minute.

Programming models such as MapReduce and Hadoop were developed to handle massive data sets, but these technologies function efficiently and practically only if data can be transmitted between various locations more quickly. Wireless network bandwidth capacity for data transmission increased apace. In the fourth quarter of 2008, as MapReduce was becoming established and Hadoop was being developed, the average internet bandwidth in the United States was 3.9 Mbps. In the first quarter of 2013, the average internet bandwidth in the United States increased to 8.6 Mbps, and continues to grow.

Point of sale machines also evolved in this period between 2000 and 2013, especially with the development of retail data containers, or transaction message standards, such as ARTS® POSLog, and de facto common messages such as IBM®'s TLOG. Both of these provide the ability to carry far more item identification and categorization data than previous transaction message formats. Further, application programming interfaces (hereinafter “APIs”), which offer direct and remote connectivity, are capable of transmitting transaction data from POS systems to third party analysts, and were streamlined and standardized in 2002, These developments led to increasing speed and created consistencies, and represent an overall migration towards universal standards, open platforms and open systems, which also speed, and streamline and facilitate any number of processes.

### SUMMARY OF THE INVENTION

Some embodiments of the invention include a sales and use tax analysis and reconciling system comprising a processor, and a first non-transitory computer-readable storage medium for tangibly storing thereon program logic for execution by the processor. The program logic includes at least a portion of a point of sale management system that comprises an item and ontology restriction interface executed by the processor and configured to receive point of sale transaction data from a point of sale transaction and process at least one transaction message from the transaction data. The point of sale management system comprises an item and ontology restriction engine executed by the processor for receiving at least one transaction message from the item and ontology restriction interface. Further, the item and ontology restriction engine is configured and arranged to receive a transaction message relating to a point of sale transaction. Further, the item and ontology restriction engine includes a process for sending the transaction message to an item and ontology restriction analysis engine coupled to a restriction database. Further, the item and ontology restriction engine includes a process for sending a transaction message comprising a transaction judgment item and ontology restriction response through the item and ontology restriction engine from the item and ontology restriction analysis engine to the point of sale management system. Further, the point of sale management system comprises a sales and use tax application program interface executed by the processor and configured to transmit totaled transaction data, and a sales and use tax engine executed by the processor for receiving the totaled transaction data.

The sales and use tax engine is configured to create instructions for an acquirer gateway, where the instructions comprise fund splitting instructions and electronic fund transfer instructions. Further, the point of sale management system comprises a sales and use tax accounting engine executed by the processor. The sales and use tax accounting engine includes processes for sales and use tax analysis and reconciliation of sales and use tax data. Moreover, the sales and use tax accounting engine is configured to transmit reconciled sales and use tax data to a funding source. Further, the point of sale management system comprises an item and ontology restriction accounting engine executed by the processor and configured to receive sales and use tax financial data from the sales and use tax accounting engine, and transmit sales and use tax accounting data to a funding source.

In some embodiments of the invention, the item and ontology restriction engine executed by the processor is configured to send transaction data to the item and ontology restriction analysis engine. In some further embodiments, the item and ontology restriction is coupled to a video analysis engine.

In some embodiments, the sales and use tax engine executed by the processor is configured to send a confirmed merchant and transaction specific report to the sales and use tax accounting engine. The confirmed merchant and transaction specific report comprising merchant and merchant sales and use tax data.

In some embodiments, the sales and use tax engine executed by the processor is configured to prepare an aggregate sales and use tax balance, and transmit the sales and use tax balance as sales and use tax bank data accounting data to a sales and use tax bank.

In some embodiments, the point of sale transaction comprises a physical retail point of sale transaction that includes a scan items step, the scan items step comprising access to an item file database.

In some embodiments, the point of sale transaction comprises an online point of sale transaction, a customer fills cart, and a customer submits card step. The customer fills cart step can include access to an item file database comprising at least one item and price file.

In some embodiments of the invention, the sales and use tax engine executed by the processor is configured to deliver fund splitting instructions when queried by the acquirer gateway.

In some embodiments, the acquirer gateway executed by the processor is configured to query the sales and use tax engine after receiving instructions from an electronic fund transfer and non-electronic fund transfer decision process. In some other embodiments, the acquirer gateway executed by the processor is configured to transmit at least one fund splitting instruction to an acquirer.

### DESCRIPTION OF THE DRAWINGS

FIGS. 1A-1C illustrate portions of a flow diagram showing system integration links and connectivity between various processes across system modules in the POS management system according to one embodiment of the invention.

FIGS. 2A-2C illustrate portions of a flow diagram showing system integration links and connectivity between various processes across system modules in the POS management system according to another embodiment of the invention.

FIG. 3A illustrates an Item and Ontology Restriction (“IOR”) engine detail according to some embodiments of the invention.

FIG. 3B provides a partial view of a POS functional block diagram for sales and use taxes according to one embodiment of the invention.

FIG. 3C provides a partial view of a POS functional block diagram for sales and use taxes according to one embodiment of the invention.

FIG. 3D provides a partial view of a POS functional block diagram for sales and use taxes according to one embodiment of the invention.

FIG. 3E provides a partial view of a POS functional block diagram for sales and use taxes according to one embodiment of the invention.

FIG. 3F-3H each provides a partial view of a portion of a data model for transmitting and accessing data according to one embodiment of the invention.

FIG. 3I illustrates a POSLog tax schema portion used by the transaction process flow according to one embodiment of the invention.

FIG. 3J illustrates a transaction message detail for item identification and ontology according to one embodiment of the invention.

FIG. 3K illustrates a table of transaction level summary information according to one embodiment of the invention.

FIG. 3L illustrates a table of transaction level summary information according to one embodiment of the invention.

FIG. 4 illustrates a SUT engine detail according to some embodiments of the invention.

FIG. 5 illustrates an IOR accounting engine detail according to some embodiments of the invention.

FIG. 6 illustrates a SUT accounting engine detail according to one embodiment of the invention.

FIG. 7 illustrates a POS screen restriction/approval display according to one embodiment of the invention.

FIG. 8 illustrates a POS restriction/approval cache according to one embodiment of the invention.

FIG. 9 illustrates one example of a system that can be used to perform at least one embodiment of the method accordance with at least one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Herein and throughout the term “online” also refers to multiple sales channels, such as, but not limited to online sales, mobile sales, kiosks, mail orders, sales call centers or any type of sale with remote buying, such as but not limited to, online, or over the phone call in-centers or catalogues, requiring an electronic fund transfer (hereinafter “EFT”). Further, herein and throughout, the term “real-time” is meant to mean meeting the far stricter latency parameters for in-store, face-to-face retail transactions, and can comprise a time period of about five seconds or less.

The following discussion is presented to enable a person skilled in the art to make and use embodiments of the invention. Various modifications to the illustrated embodiments will be apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In some embodiments of the invention, the applicable tax for online applications can be the use tax. Use taxes are a type of excise tax levied in the United States by state governments. It is assessed upon tangible personal property purchased by a resident of the assessing state. Use taxes apply when a resident of the assessing state purchases an item that is not subject to his home state's sales tax. Usually, this is due to out-of-state purchases, often, and increasingly, occurring online. Typically, the use tax is assessed at the same rate as the sales tax that would have been owed had the same goods been purchased at the state of residence. In some embodiments, this tax will indeed be a sales tax, as the online buyer and the online merchant nexus reside in the same applicable taxing jurisdiction.

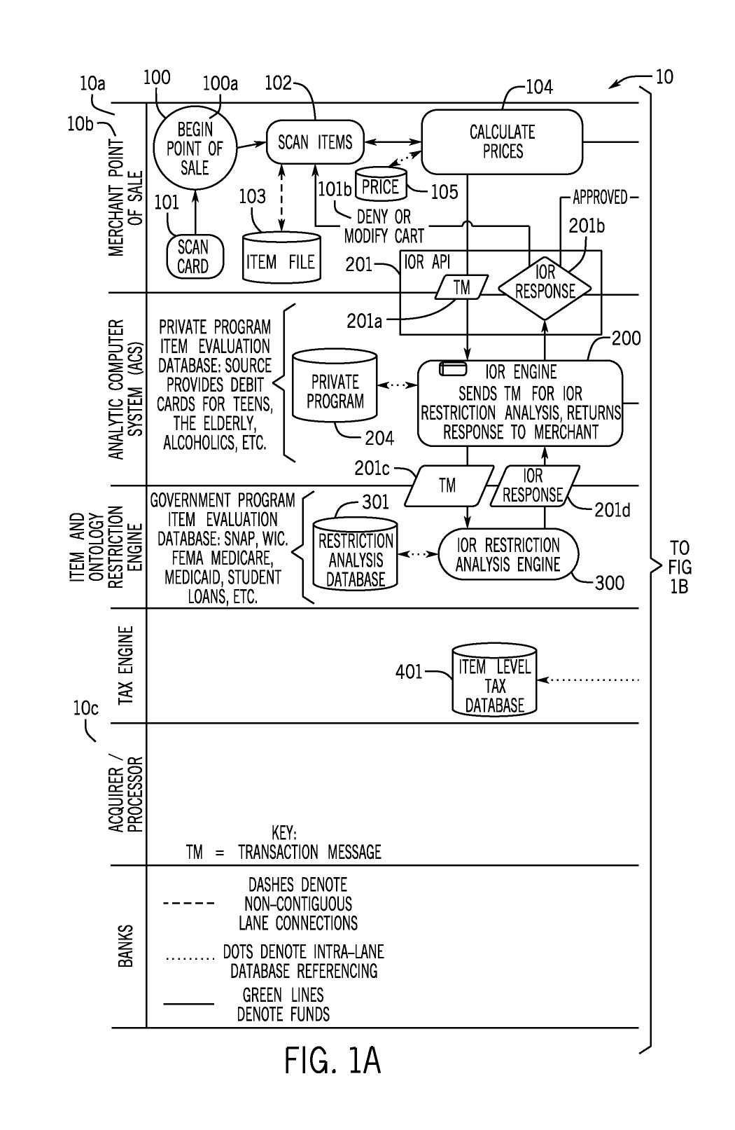

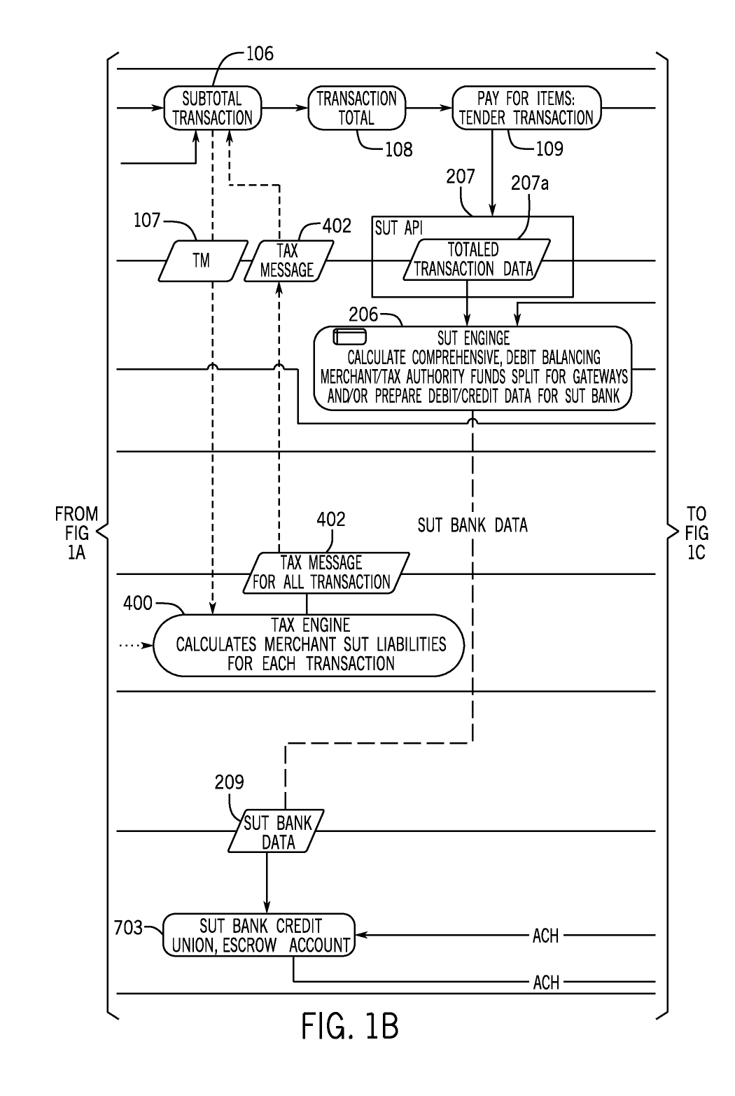

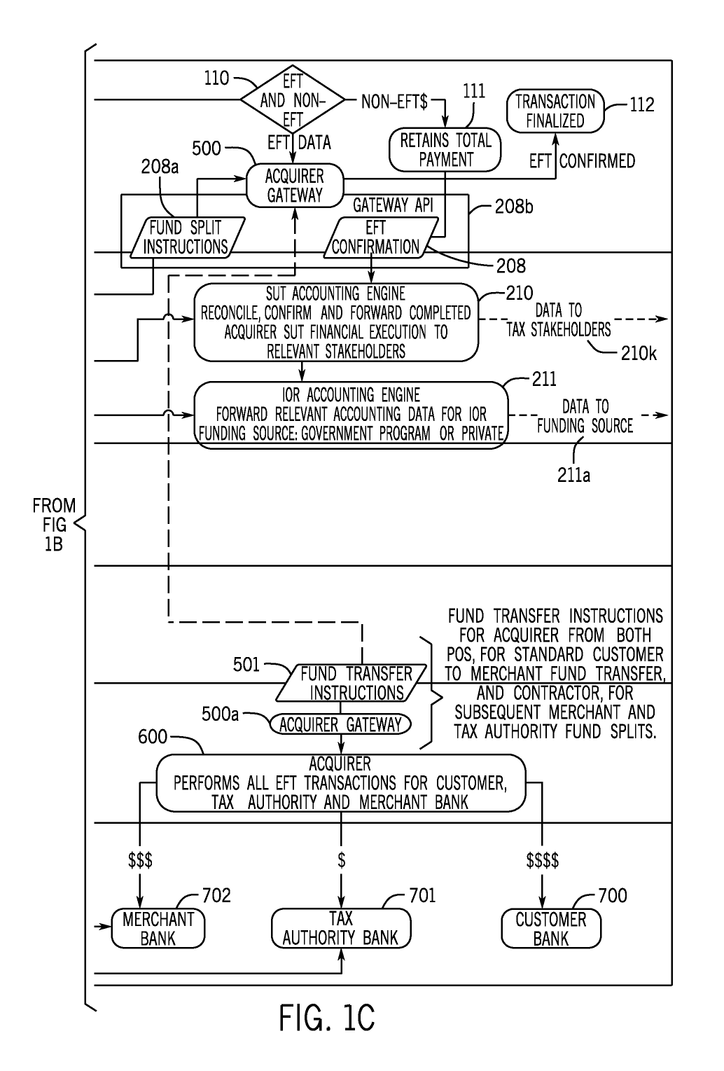

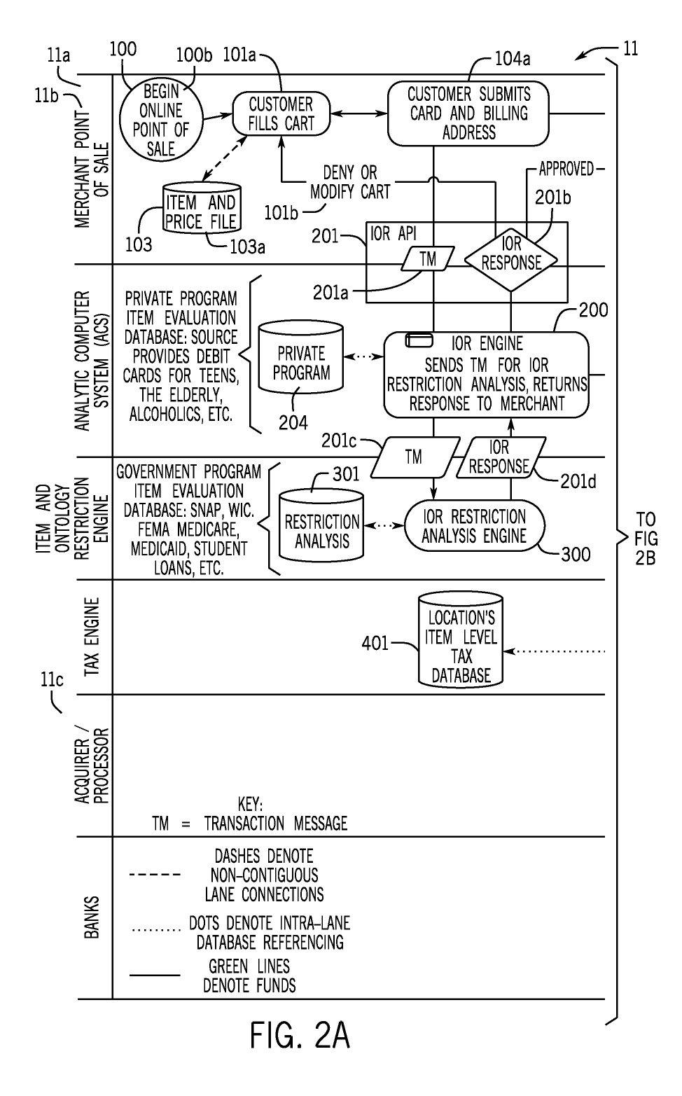

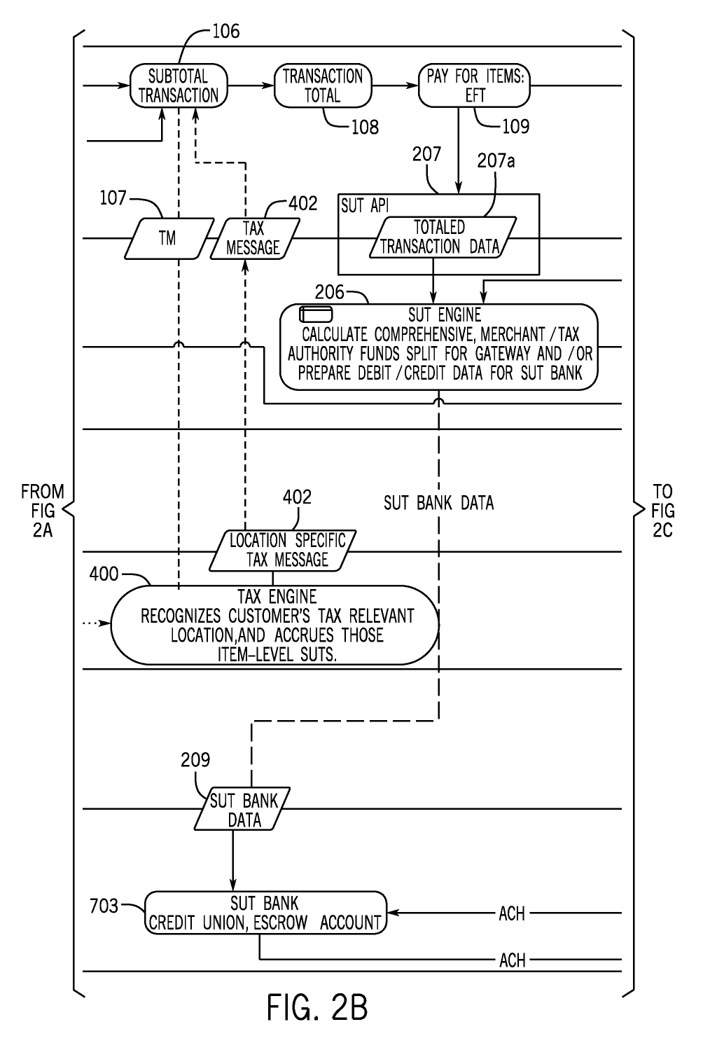

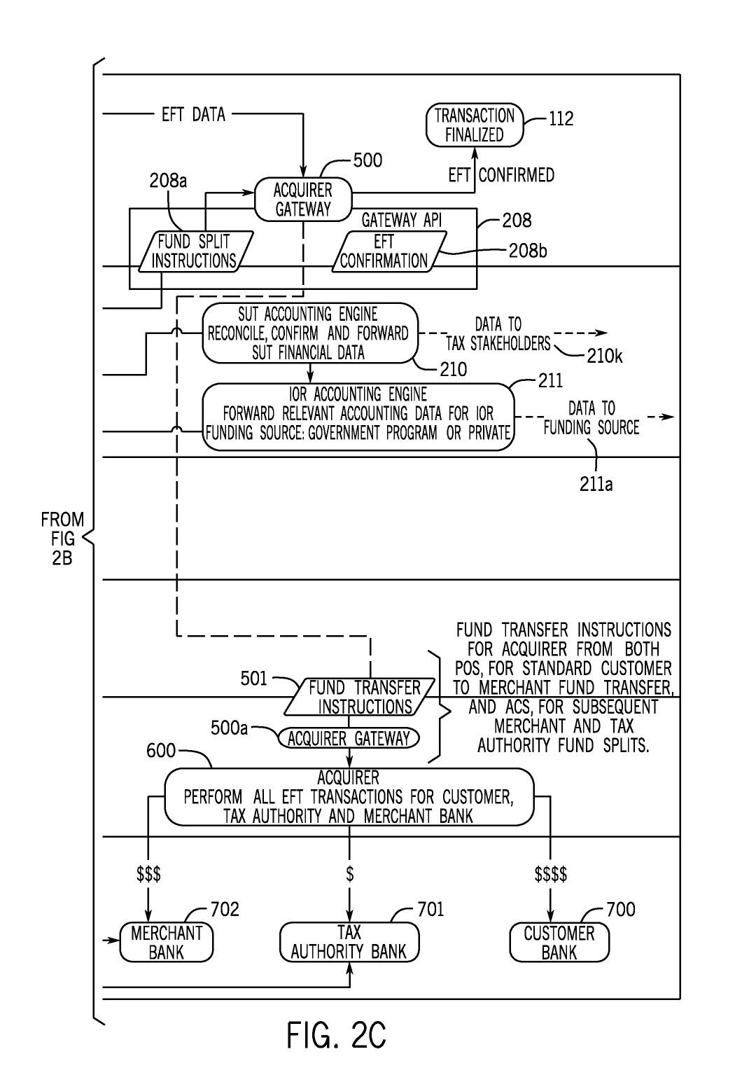

It is important to understand that the technologies used throughout the processes of some embodiments of the invention to execute the full scope of embodiments can vary. For example, in the case of SUT calculations, presently, most POS systems perform their own SUT calculations internally. Some systems, however, reference outside servers, such as servers from Vertex or Avalara, Inc., to calculate SUT. For example, the tax engine 400 as shown in FIG. 1A-1C illustrating the POS management system 10 can reside in the POS management system 10 in some embodiments, and out of the POS management system 10 in some other embodiments. In the latter embodiments just described, one or more logic elements of the POS management system 10 can couple or network to the tax engine 400 or can be contracted to a third-party service like Vertex. Further, in some embodiments, the tax engine 400 can couple to an item level tax database 401. Another example is the delivery of SUT fund splitting instructions. Some acquirers can have their own gateways, such as Heartland's Portico. In this instance therefore, the particular flow of relevant SUT funds splitting data would not require a third-party gateway per se, but at least some use the acquirer's gateway. For this reason, in the acquirer gateway is not given its own lane, but shown to reside within more than one lane (both in the POS lane 10b and the acquirer lane 10c in FIGS. 1A-1C showing the group of lanes 10a) and FIGS. 2A-2C (showing the group of lanes 11a and POS lane 11b and the acquirer lane 11c), and represented as acquirer gateways 500, 500a in each of these embodiments.

The examples named above are meant to demonstrate that the recognition, extraction, transmission, identification analysis, restriction list matching, tax calculations, SUT data preparations for both EFT and non-EFT transaction, and all other functions performed herein can occur through different combinations of API hardware, software, and internet services etc., that are embodied within the system and methods of the POS management system 10. Further, the pathways specifically illustrated are not meant to limit the patent to these particular processes or systems. Some embodiments of the invention include methods and systems to perform these operations on POS transactions per transaction, and substantially in real-time.

Some embodiments of the invention include an SCF system and method that can send, prior to tender phase, proposed transactions to a central database, and analyze transaction data to identify specific items or item ontology as needed. Further, in some embodiments, the system can match these identities to the applicable program database, enabling the system to render a judgment either approving, denying, or offering to modify a given transaction based on said program parameters. In some embodiments, the system can then send the judgment back to the originating POS, all within an acceptable, in-store, face-to-face latency of five seconds or less in some embodiments. Subsequently, now that relevant transaction data is in the system in a transmittable language such as, but not limited to, xml used with Java® (Java® is a registered trademark of Oracle Corporation), in some embodiments, the transaction data can immediately be transmitted to the relevant, applicable program databases, so it is now available for review, analysis and accounting. In some embodiments, the system can eliminate or streamline work by both the merchant and program authority, enable item-level control over the execution, monitoring and auditing of program spending. Further, in some embodiments, the system and method can streamline subsequent accounting, as well as help inhibit fraud by eliminating time lapses through direct oversight and access to specified databases within a given program controlled by a government agency.

Some embodiments of the invention can comprise one or more of the methods described herein by government spending programs, where the government would benefit greatly by including a direct, and precise control of program spending, per item, per transaction, and prior to tender settlement. In some embodiments, this can eliminate any number of fraudulent practices. In some embodiments for example, the use of one or more of the methods described herein for student loans can enable a system with restrictions on spending categories. In some further embodiments of the invention, the use of one or more of the methods described herein for other programs such as SNAP can allow broad categories for this same reason to enable the ability to approve or deny purchases on an item-level basis.

Some further embodiments of the invention include the use of one or more of the methods described herein for other programs such as the Federal Emergency Management Agency (hereafter “FEMA”) which focuses primarily on loans and damage payments. In some embodiments, this can allow FEMA to create item-level, ontologically defined disaster spending. In some embodiments this can allow FEMA to develop and manage immediate disaster relief programs. Some embodiments of the present invention can also enable all said programs to have immediate access to item-level transaction information for subsequent analysis and accounting. In some embodiments, this can allow streamlining or eliminating expensive and time consuming processes that are presently performed after the fact. Such programs include, but are not limited to, WIC, SNAP, Medicare, Medicaid and FEMA, student loans, etc.

Some further embodiments of the invention include the use of one or more of the methods described herein for private industry uses such as Red Cross, an emergency service that would benefit greatly from the ability to precisely control and define spending in disaster struck areas for lodging, food, fuel, building materials, etc., and would greatly benefit from the subsequent capacity to analyze and account for such spending.

Some further embodiments of the invention include the use of one or more of the methods described herein for controlled spending by private debit cards such as so called “teen cards”. In some embodiments, this can enable parents or guardians to control the spending of a chosen benefactor, who could select any number of controlling parameters such as time, location, item, etc. In this instance, the use of one or more of the methods described herein can include substantially real-time monitoring of this spending. In some embodiments, such a card could have many uses, including, but not limited to, a card for alcoholics that prohibits the buying of alcohol, restricting buying at specified times and places, for just lodging, or food, etc.

Some further embodiments of the invention include the use of one or more of the methods described herein for item-level information of buying behavior, which in some embodiments, can be of value to retailers. This information can be made available within strictly understood legal parameters protecting the privacy of individuals and specific merchant identities, while offering item-level buying data for analysis.

Some further embodiments of the invention include the use of one or more of the methods described herein to calculate, collect and distribute SUT, on any time horizon, including within the above defined real-time parameters. Some embodiments of the invention can enable the Analytic Computer System (hereinafter “ACS”) to do several things in a unique combination. For example, in some embodiments, the ACS can analyze, collect and distribute SUT in any time horizon including substantially in real-time. In some embodiments, the ACS can analyze, collect and distribute SUT for every transaction that passes through any POS system including cash transactions. Further, in some embodiments, the ACS can analyze, collect and distribute SUT on a wide geographic basis while denying as non-compliant any transactions not using the system that in some embodiments, can force adoption and compliance.

In some embodiments, each state that wishes to analyze, collect and distribute SUT can contract with the ACS to implement the system and methods of the invention on a state-wide basis. For example, in some embodiments, the state can require credit card processors to submit all EFTs originating in the state to the ACS (as contractor to or proxy for the state) for ontology restriction and SUT analysis using the system and methods of the invention. In some embodiments of the invention, all retailers are provided a custom downloadable API for their POS systems. In some embodiments, the API can be provided free of charge through the ACS website. In some embodiments, the API can enable the ACS to capture the full transaction message (such as a POSLog, TLOG or equivalent data set) for every transaction substantially in real-time.

In some embodiments, any attempted EFT with an origin or destination in the state can be rejected as non-compliant unless and a transaction message is provided to the ACS. In this way the ACS can capture transaction data sufficient for item restriction analysis. Further, all SUT due can be collected, not only from retailers who currently and fairly report their sales, but also from retailers who might otherwise go out of business or under-report after collecting SUT, and from retailers who fail to register with the state, use dongles, etc. In this instance, the state burden for registration of retailers and for processing of sales and use tax reports is replaced with the vastly simpler ACS system consisting of requiring the API. This enables collection and analysis of the transaction message, which then enables collection and distribution of SUT on behalf of the state.

In some embodiments of the invention, each transaction message survives only until the item or item ontology restriction and SUT analysis is completed, and then the transaction message can be destroyed. In this way, the retailer's proprietary inventory and pricing data is never stored, and cannot be analyzed by the ACS or the state. Further, the ACS does retain the record of item or item ontology restriction denials and SUT data per retailer. Therefore, in some embodiments, item and item ontology restriction denials and tax category sales totals can be analyzed for any time horizon, geographic boundary or specific business.

Some embodiments of the present invention can enable identification of items without being limited to shared, health care UPCs, or needing the merchant to share proprietary inventory codes. In addition, some embodiments of the invention include the capacity to match an item to the relevant program ontology. For example, in some embodiments, a single item, such as an automobile carburetor, can be taxed in one or more different ways depending on use, whether it's being bought by or sold from an auto parts store, or whether it is being shipped to a manufacturer, or to an auto repair shop. Here the item's ontology is relevant, not just the item identification itself.

FIGS. 1A-1C illustrate portions of a flow diagram showing system integration links and connectivity between various processes across system modules in the POS management system 10 according to one embodiment of the invention. As depicted, in some embodiments of the invention, the POS management system 10 can enable substantially real-time interconnectivity for SUT related transaction flows, enabling information to flow between the POS (shown as POS 100) and a wide variety of stakeholders, including sources providing funds, government benefit programs (funding source 211A), and states collecting sales and use taxes such as SUT (tax stakeholders 210k). In some embodiments of the invention, this substantially real-time interconnectivity can create the capacity for the sources providing funds to monitor and control POS transactions, on an item level or item ontology basis, and during the transaction at the checkout counter, and before it finalizes. In some embodiments of the invention, this also creates the ability for states to collect and account for SUT on any chosen time horizon, and in some embodiments per transaction. Finally, in some embodiments, because the data includes open, standardized formats, such as, but not limited to, xml or JavaScript object notation, the data is in a standardized format, and can be instantaneously sent to, and recognized by, stakeholders 210k, 211 a for immediate accounting. Further, some embodiments of the invention enabled by the system and methods of the POS management system 10 can encompass SCF which can operate during the transaction and through the tender exchange. In this instance, POS transactions can occur substantially in real-time, vetting individual transactions on an item or item ontology level basis with the capacity to control that transaction, and subsequently to transmit relevant data to the specified program databases for analysis and accounting. Further, SUT embodiments can include SUT calculations, collections and distributions, can occur substantially immediately after the final tender calculation and, in some embodiments, as part of the actual tender exchanges, with the relevant customer, merchant, acquirer and tax entity banks. In some embodiments, each of these two embodiments can be applied together, as presented in FIG. 1A-1C, or individually, independent of each other. That is to say, in some embodiments, it is possible to run the SCF system without subsequently engaging the SUT embodiment as described above, and vice-versa. In some embodiments, the SUT embodiment requires the SCF system and an IOR engine, unique to the present invention, for SUT categorizations. However, in some embodiments, the SUT embodiment can likewise be engaged and function without the SCF embodiment.

In some embodiments of the invention, the POS management system 10, the data sharing systems and methods can be developed to allow a single and central process such as the IOR engine to recognize, analyze, sort, store, transmit and track data for a multiplicity of said programs and uses. The POS management system 10 shown in FIG. 1 illustrates a flow diagram depicting in-store, face to face retail POS transactions (represented as 100a), because they present the most problematic retail scenarios. This is due to latency issues and the complexity of transaction payment possibilities (e.g., coupons, returns, loyalty programs, gift cards, tax-exempt buyers, EBTs for government programs such as WIC, Medicare etc.). Those skilled in the art will recognize that the present invention also encompasses the full range of transactions and sales channels, including, but not limited to, online sales, kiosks, cable call-in channels, sales call centers, mail order, mobile sales apps, device payment interface dongles such as Square, professional service transactions such as for legal services, construction etc.

In some embodiments, POS systems can readily recognize, extract and export relevant transaction data, and then readily receive return IOR judgments and SUT data, all without APIs. In some embodiments, item and ontology identification becomes simplified for both IOR and SUT applications due to more universal coding systems (much like prescription drugs, which all share the same codes regardless of merchant). In some embodiments of the invention, computer language recognition capabilities simplify item and ontology identification, for both IOR and SUT applications. In some embodiments, both gateways and acquirers streamline capabilities for accepting fund splitting instructions for a single transaction, thus simplifying the SUT fund splitting process where customer funds are divided by the acquirer between merchant and appropriate tax authority accounts.

Some embodiments of the invention can include transactions that can be processed within a transaction framework type, including a retailer transactor, an IOR Engine 200 transactor, an acquirer/bank transactor, an IOR transactor, an SUT engine transactor, and a tax authority transactor. As shown, in some embodiments, each transaction framework type can include an action type, such as scan items, scan card, calculate prices, etc. In some embodiments, each transaction framework type can include data transfer to and from a database (e.g., an item file database or a price lookup database). Moreover, each transaction framework type can include a transaction message that can follow an action type.

In some embodiments of the invention, a transaction process can begin at the POS that can comprise scanning of items in the scan items 102 and from the item file 103. Further, some embodiments include a scanning of a customer's EFT device, including, but not limited to, credit or debit cards, EBT cards, Google Wallet™, Apple Pay™, smart cards or any device that triggers an EFT. In some embodiments, the scanning of the customer EFT device (represented as scan card 101) is positioned so it can represent a pre-swipe prior to item scanning. In some embodiments, this pre-swipe can occur within a physical store (where the POS 100 comprises a POS 100a, a face-to-face retail transaction), or as a swipe or data entry after the shopping basket is full and scanned (step 102), as would occur with an online purchase (where the POS 100 comprises a POS 100b). In some embodiments, the customer EFT device pre-swipe (scan card 101) can allow at least one embodiment of the invention to alert and cue up one or more first-identifier databases. In some embodiments, the one or more first-identifier databases can comprise customer databases and merchant databases. In some further embodiments, first-identifier databases can include the specific program databases, WIC, SNAP, student loans, Medicare, etc. Google Wallet™ payment service is a trademark of Google Inc. Apple Pay™ is a trademark of Apple Inc.

In some embodiments of the invention, the POS management system 10 generates a unique transaction identifier for each transaction. In some embodiments, this identifier, which tags both particular merchant and specific transaction, can remain with the transaction throughout all processes and functions of the POS management system 10, allowing for the ongoing identification and tracking of each specific transaction.

In some embodiments, substantially simultaneous with the completion of item scanning in calculate prices 104, a complete retail schema transaction message (TM 201a), such as a POS transaction log, such as, but not limited to, IBM®/Toshiba's TLog or “POSLog” (an industry open standard retail schema developed by “ARTS®”, of the National Retailer Federation) can be sent by an IOR API 201 interface via a TM 201a to the IOR engine 200. In some embodiments, the POS management system 10 can access one or more price databases 105 to access pricing information. IBM®, and the IBM logo, are trademarks or registered trademarks of International Business Machines Corp., registered in many jurisdictions worldwide.

In some embodiments, each of the APIs shown, IOR API 201, SUT API 207 and gateway API 208 can comprise multiple APIs, or can combine into fewer APIs, if it facilitates various processes more efficiently. Indeed, in some embodiments each function illustrated on the border between ACS and the POS can represent a distinct API.

In some embodiments, for example, but not limited to, the digital receipt is accessed and sent. In some embodiments, transaction messages such as POSLog can carry specific queries with them, and subsequently return those responses to the query source.

In some embodiments, the IOR engine 200 can then perform various functions within the ACS transactor framework. For example, in some embodiments, first identifiers are confirmed, including the identity of the customer and the respective program. In some embodiments, an EBT card identifies both the individual and the respective program (e.g., government programs such as student loans, Medicare, WIC, SNAP, or private sector programs such as Red Cross, or a Flexible Spending Account (hereinafter “FSA”) for health insurance).

In some embodiments, the first identifiers can serve as enough information to initiate restriction protocols. For example, time can be a restrictive category in itself, such as for a teen card being restricted for use after midnight. Location, both geographical and store category can also be a restrictive category. For example, in some embodiments, a card restricted for alcohol, location and time, and for example being recognized as being used at Joe's Discount Liquors, in Las Vegas, at 2:00 a.m. would substantially, immediately and on all counts initiate restriction protocols. However, in some embodiments, additional information is usually needed.

In some embodiments, IOR API 201 collects any persisted item data at this time, shown from calculate prices 104. In some embodiments, IOR API 201 can export it via TM 201a to the IOR Engine 200.

In some embodiments, the IOR Engine 200 can review the first identifiers to confirm the merchant, the beneficiary customer, and the relevant program. In this instance, the relevant program can be an individual teen card, an insurance FSA, or a government program such as WIC or Medicare. In some embodiments, once identified, the IOR Engine 200 can forward the transaction log to an IOR Restriction Analysis Engine 300.

In some embodiments, and as depicted in FIGS. 1A-1C, for primarily, but not solely, private sector uses such as, but not limited to, teen cards, the IOR restriction analysis engine 200 can be within the configuration of ACS. In some embodiments, such applications would reference database private program 204 for item restriction data matching. It is important to note, that such functions and processes can occur in different ways and locals. For example, in some embodiments, such engines can be located and maintained within ACS, by third party large scale data management companies such as SAS or IBM®, or within the respective SCF program itself. SAS® and all other SAS Institute Inc. product or service names are registered trademarks or trademarks of SAS Institute Inc. in the USA and other countries.

In some embodiments, and as depicted in FIGS. 1A-1C, for larger scale programs, such as but not limited to government programs or FSA insurance programs, the IOR Restriction analysis engine 300 can be maintained and operated by a contracted third party.

In some embodiments, regardless of the location and party operating the IOR restriction analysis engine 200, or the location and party operating the IOR restriction analysis engine 300, these engines analyze the transaction data carried by TM 201c to identify the items for both item and ontology. In some embodiments, the proposed shopping basket of items is vetted against the database containing that particular program's approval or restriction list. In some embodiments, the list in this database can represent an entire program, such as but not limited to, food programs like SNAP or WIC, where perhaps millions of people are enlisted on the same set of restrictions and/or approvals.

In some embodiments, the database list can also represent smaller subgroups of people, or even individuals, within a given program, with specific subgroup or individual restrictions and/or approvals. For example Medicare or Medicaid can have any number of subgroups according to age, particular infirmity, etc.

In some embodiments, restriction/approval lists can also be quickly created for a specific instance or event; for example FEMA or Red Cross can create a unique, situational approval/restriction list to respond to a specific disaster.

In some embodiments, such as for private sector uses, the restriction list can contain just a few items that relate solely and specifically to an individual beneficiary.

In some embodiments, the IOR restriction analysis engine 300 can respond to the proposed transaction via IOR response 201d to the IOR engine 200, which identifies the appropriate merchant and specific transaction. In some embodiments, the IOR engine 200 then identifies the specific merchant and transmits that specific transaction judgment back to said merchant via IOR response 201b.

In some embodiments, if, after the IOR vetting process, all the items are approved, the IOR engine 200 can send a confirmation through the IOR response 201b, informing the POS that the shopping basket is approved. In some embodiments, the IOR API 201 sends this shopping basket approval directly to subtotal transaction 106, where the POS transaction would resume, continue and finalize as normally unfolds.

In some embodiments, if items are not approved, IOR response 201b can send a message back to scan item 102, identifying the restricted items, and where the POS either ends the transaction or allows the proposed shopping basket to be modified, as according to pre-established contracts and protocols. In some embodiments, in case of modification, the restricted item or items can be removed from the shopping basket to conform to contracted parameters, and in some embodiments, the entire IOR process repeats itself for the modified shopping basket.

In some embodiments, such item and ontology identifying analytics can be run within acceptable in-store, face-to-face latencies so that the entire process occurs within an acceptable in-store latency of about five seconds or less. For example, in some embodiments, the process from sending transaction message TM 201a through the IOR engine 200 to the IOR restriction analysis engine 300, and back through the IOR engine 200 with a definitive transaction judgment IOR response 201d to the POS can occur within an acceptable in-store latency of about five seconds.

In some embodiments, the pathway back to the POS register for the IOR approval/denial/modify judgment processed by IOR response 201b can be well established, and can use standardized formats, currently used primarily to receive approval/denial messages from the gateway regarding the availability of customer funds for EFT transactions. In some embodiments, this return pathway is capable of receiving additional messages. Many POS systems support register specific screens where the clerk can read such messages. Though this screen is maintained and controlled by the POS, in some embodiments it can, by prior agreement, post return messages to the register clerk, interfacing with a handshake from IOR API 201 using standardized formats.

In some embodiments, a message explaining the reason or reasons for transaction denial (usually because the customer has attempted to purchase a restricted item) can appear on the POS screen 1000a so the clerk can clarify the judgment. In some embodiments, because the judgment occurs within the POS and beyond the power of the clerk to modify, this relieves the merchant, and specifically the register clerk, from having to personally police programs where in some cases, in some circumstances, such as, but not limited to, SNAP or WIC, they presently do.

Conversely, in some embodiments, a list submitted by a source could contain items that must be bought, or can only be bought. For example, if a construction contractor sends a worker to buy certain items from a store (e.g., The Home Depot), the present inventions could assure that exactly the right part is being bought.

In some embodiments, if there was not an EFT device pre-swipe, said device can be swiped at pay for items 109. In some embodiments, IOR API 201 can then facilitate the transmission of the proposed shopping basket transaction message, and send it to the IOR engine 200, as per the SCF process described above.

In some embodiments, both the private program 204 and/or the restriction analysis database 301 can maintain collected, or through negotiated agreement with merchant, said merchant's proprietary inventory, or stock-keeping unit, or other identifier systems to enable item and ontology identification.

In some embodiments of the invention, after the item and/or its relevant ontology have been identified by the IOR process, they are matched to the specific and corresponding program and/or the specific customer databases which can reside in either the IOR engines 200 and/or IOR restriction analysis engine 300. In some embodiments, after items from the proposed shopping basket are matched against the appropriate database item restrictions, the IOR engine 200 can render a judgment, either approving, denying, or offering to modify by specifying which item or items must be removed from the basket (shown as the deny or modify cart step 101b). In some embodiments, this return judgment is sent via the IOR engine 200 through the IOR response 201b utilizing IOR API 201 back to the originating POS, using either a standardized format or the same transaction message format it was sent as to be recognizable by the originating POS.

In some embodiments, the register sub-totals the approved shopping basket at subtotal transaction 106, which in some embodiments can be followed by a transaction total 108 step, and a pay for items 109 step. In some embodiments, this is where the SUT process can be initiated.

States, counties and municipalities have the ability to establish sales and specialty tax rates, tax districts and tax exemptions (e.g., for hotels, liquor, automobiles, cigarettes etc.). Broadly stated, the SUT gap, addressed by some embodiments of the invention is the difference between the amount of sales and use taxes that are legally due and what is actually collected. At 13.2%, the SUT gap estimated for Minnesota in the most thorough study of the problem, the amount of legally due but uncollected sales and use taxes in the United States alone is many billions of dollars per year.

Additionally, those skilled in the art would understand how the SUT, once collected, can then be distributed by a variety of means from immediate deposit with the appropriate state Department of Revenue (hereinafter “DOR”) bank to the various stakeholders and designated recipients, including, but not limited to, towns, counties, school districts, special service districts etc. In any case, benefits from the capacity to collect, distribute and account for SUT, on virtually any time horizon including real-time, would be clear to one skilled in the art. Presently there can be political or legal issues with third party contractors distributing SUT funds out of state accounts; however, in some embodiments, these distribution systems and methods described herein could be licensed and overseen by said state authorities.

Finally, some embodiments of the invention create an appropriate audit trail and informs relevant accounting mechanisms. It will be readily apparent to one skilled in the art how such data, also available on any time horizon that can include per transaction, can be of great use to any State DOR. For example, this could include, but not be limited to, accounting for and reconciling the SUT, tracking and analyzing performance of any sector of the economy, or for budget forecasts and applications.

As described earlier, in the case of SUT calculations, presently, most POS systems perform their own SUT calculations internally. Some systems, however, reference outside servers, such as Vertex or Avalara, to calculate SUT. However, regardless of how taxes are calculated, the POS either internally or externally sends the subtotal transaction 106 data via TM 107 to this function. In some embodiments, after pay for items 109, any latency issues is no longer a concern as the beneficiary customer has paid for their approved shopping basket, and is therefore free to leave.

In some embodiments, at pay for items 109, the SUT engine 206 can receive two key pieces of data from the POS through SUT API 207 via totaled transaction data 207a. In some embodiments, these can include the complete list of shopping basket items, as previously discussed with the IOR, and the final payment type (comprising EFT or non-EFT).

In some embodiments, EFT devices include credit or debit cards, EBT cards, Google Wallet™, Apple Pay™, smart cards or any such payment device which triggers an EFT. Non-EFT tenders includes cash, checks, vouchers or any other type of payment that does not require an EFT. Google Wallet™ payment service is a registered trademark of Google, Inc.

In some embodiments, the SUT engine 206 recognizes the tender type. If tendered by an EFT mechanism, the transaction is segregated to have that specific transaction's merchant SUT balanced from that specific transaction. For example, in some embodiments, if an item costs $100, and the SUT is 10%, the SUT due on this transaction is $10, for a transaction total of $110. In some embodiments, the SUT API 207 sends this total via totaled transaction data 207a to the SUT engine 206, which recognizes that of this $110 transaction, and $100 goes to the merchant account and $10 is due to the relevant tax authorities.

In some embodiments, the SUT Engine 206 can then create instructions for the acquirer gateway 500 for this transaction-specific merchant/tax authority fund split. In some embodiments, these instructions can then be cued to await a transaction-specific query from the acquirer gateway 500.

In some embodiments, once the acquirer gateway 500 receives the EFT instructions from the EFT and Non-EFT decision box (e.g., step 110 in FIG. 1C), in some embodiments it queries the SUT engine 206 for fund splitting instructions for this specific transaction, through gateway API 208 via fund split instructions 208a.

In some embodiments, the SUT engine 206 recognizes this query and delivers these EFT specific transaction fund splitting instructions back to the acquirer gateway 500 through gateway API 208 via fund split instructions 208a. In some embodiments, the acquirer gateway 500 as shown can comprise the acquirer gateway 500a which then delivers these fund splitting instructions to the acquirer 600 via fund transfer instructions 501.

In some embodiments, the acquirer gateway 500 will not query the SUT engine 206 for SUT fund splitting instructions, but it can have the capacity to internally receive such data from SUT Engine 206, via fund split instructions 208a and cue said data within its framework.

Returning to the example above, in some embodiments, the acquirer 600 debits the customer bank 700 account the $110 for the transaction, per usual. Then, however, the acquirer 600 has an additional set of fund splitting instructions. For example, in some embodiments, instead of delivering the full $110 to the merchant account (per usual), the acquirer 600 executes the instructions from the SUT engine 206 through the gateway to segregate the $10 SUT. In some embodiments, this $10 SUT is transferred to the relevant state tax authority bank 701 account. Therefore, in some embodiments, the merchant bank 702 account receives the $100 due for the item, and the tax authority bank 701 account receives its $10 due in SUT. In this way, the merchant EFT transactions remain balanced and current with SUT.

In some embodiments, with a non-EFT transaction, such as, but not limited to, cash, checks, or any other transaction that does not trigger an EFT, both the merchandise total and the total SUT are collected and retained by the merchant in retains total payment step 111.

In some embodiments of the invention, the non-EFT problem can be solved in at least two different ways, for example encompassed by “non-EFT SUT Balancing” and “SUT Bank,” to encompass variations of merchant funded accounts. In some embodiments, the non-EFT SUT balancing solution evolves from what is described above for single EFT transactions, where SUT is extracted and paid for just that specific EFT transaction. However, in some further embodiments, any debits or credits accrued by prior non-EFT transactions can also be calculated in and resolved by the fund splitting mechanism already described herein.

Returning to the previous example, the $110 EFT transaction was split into a $100 payment to the merchant and $10 SUT to the tax authority. In some embodiments, if the transaction prior to this example EFT transaction tendered a non-EFT payment of $55 ($50 item plus $5 SUT), then the merchant would have kept the entire $55 and there would be a residual $5 SUT debit. In some embodiments, the SUT API 207 can subtract this $5 SUT figure of accrued taxes from the POS, and deliver it to the SUT engine 206 via total transaction data 207a. In some embodiments, the $5 SUT amount can then be cached and ready to add to the SUT debit of the next transaction. Following immediately after this non-EFT transaction we have the example $110 EFT transaction, with its $10 SUT. In some embodiments, the SUT engine 206 can search its database for cached and accrued SUT from prior transactions to reconcile, and can find this $5 debit. In some embodiments, the SUT engine 206 totals these two SUT owed debits (including the $10 from the current EFT and $5 from the prior cash transaction) to an aggregate total of $15. The SUT engine 206 can then create instructions for the acquirer gateway 500 for a balancing, and comprehensive merchant/tax authority funds split of $15. In some embodiments, these instructions are then cued, to await a transaction-specific query from the acquirer gateway 500. In some embodiments, the acquirer gateway 500 delivers these fund splitting instructions to the acquirer 600 via fund transfer instructions 501 through the gateway API 208. In some embodiments, the acquirer gateway 500 as shown can comprise the acquirer gateway 500a which then delivers these fund splitting instructions to the acquirer 600 via fund transfer instructions 501. In some embodiments, the acquirer 600 debits the $110 from the customer bank 700 account. Then, in some embodiments, the acquirer 600 executes an additional set of fund splitting instructions. Consequently, in some embodiments, instead of delivering the full $100 to the merchant account and $10 SUT to the tax authority (as in the first example above), the acquirer 600 executes instructions to segregate the aggregate $15 SUT. Further, the acquirer 600 executes instructions to deposit $95 in the merchant bank 702 account, and the combined SUT liability of $15 into the tax authority bank 701 account, which balances the merchant for both transactions. In this way, the merchant can remain balanced and current with their SUT liability.

Store transactions can be very complex. There are, for example, but not limited to, coupons, loyalty programs, vouchers, gift cards, purchase orders, item returns, tax exempt buyers, etc. For example, item returns create a tax credit for the merchant that must also be reconciled. Therefore, in some embodiments, there will be cases where prior transactions create merchant credits for tax already paid on the returned items. For instance, in some embodiments, if the item return total was $110, this would create a $10 SUT credit owed to the merchant. In some embodiments, if the subsequent EFT transaction were only $55, then that creates a $5 SUT debit. In some embodiments, the SUT Engine 206 can reconcile these two transactions to find that not only would no taxes be debited from the current $55 EFT transaction, but there remains a $5 Merchant SUT credit owed to be reconciled by future EFT transactions.

In some embodiments, the system and methods of the POS management system 10 can, regardless of the payment system or tender, be capable of calculating SUT and delivering fund splitting instructions or data into that payment system in a way that keeps the merchant current with their SUT liabilities.

Some embodiments of the invention can keep the merchant current and balanced with non-EFT SUT payments through at least two methods. The first method, as cited above, can execute non-EFT SUT balancing, by maintaining a running, aggregate balance of owed SUT, and can create fund splitting instructions for the acquirer gateway that keep the merchant SUT payments current.

In some embodiments of the invention, said non-EFT SUT balancing applies to predominantly EFT businesses, for example, but not limited to, hotels, online purchases etc. In some embodiments, the second method takes this same running, aggregate SUT balance created by SUT engine 206, and transmits that SUT balance as accounting data to the SUT bank 703 via SUT bank data 209. In some embodiments, the SUT bank 703 can comprise Credit Unions, escrow accounts (such as lottery sweep accounts), and the merchant's bank account. In some embodiments, the actual fund balancing can occur based on the aggregate SUT data supplied by the SUT Engine 206 and between one or more of these financial institutions through ACH transfers. Further, this can occur on virtually any chosen time horizon, including per transaction if so desired, though ACH batching is presently settled over longer periods of time, such as daily.

In some embodiments, the entire SUT resolution process presented herein is self-contained and can function alone, separately and independently from the IOR process.

In some embodiments, all of the SUT resolution processes presented herein can function independently of each other. For example, EFT SUT balancing, non-EFT SUT balancing and SUT bank can each function alone, separately and independently from each other to address respective aspects of SUT calculating, resolving and accounting.

In some embodiments, all of the SUT resolution processes presented herein can function altogether or in any combination to create comprehensive SUT resolution. In some embodiments, the EFT SUT balancing, non-EFT SUT balancing, and SUT bank working in combination can address virtually all SUT resolution scenarios.

In some embodiments, the acquirer gateway 500 receives return confirmations of fund splitting back from the acquirer 600 per usual. This confirmation is delivered to the POS and finalizes that specific transaction in transaction finalized 112.

In some embodiments, the gateway API 208 receives this same EFT fund splitting confirmation from the acquirer gateway 500, and forwards that EFT confirmation via EFT confirmation 208b to both the SUT accounting engine 210, and the IOR accounting engine 211.

In some embodiments, at this point, both the IOR and SUT functions have completed their actions. The IOR list has been satisfied and confirmed, and the merchant SUT has either been resolved or set into motion, in process in third party hands (such as, but not limited to, ACH or EFT funds batching). Some further embodiments can include respective accounting functions.

In some embodiments, the SUT accounting engine 210 reconciles confirmed SUT resolution data (whether SUT EFT balancing, non-SUT EFT balancing or SUT bank) with the original SUT Engine 206 calculations sent to the respective processes (these should match). In some embodiments, the SUT accounting engine 210 (comprising a configuration of databases and servers such as the merchant account database 210g and SUT account 210h) can then make the confirmed and reconciled SUT data available to the relevant stakeholders in standardized formats. In some embodiments, these stakeholders are the merchant 210a, the taxing authority, the SUT funds recipients (i.e., tax stakeholders 210k) such as, but not limited to, relevant municipalities, school districts, special service districts, fire and police departments, etc. In some embodiments, the SUT accounting engine 210 consolidates the confirmed and reconciled SUT data and maintains it in a central database that said relevant stakeholders 210k, 211 a (shown in FIGS. 1C and 2C) can securely access. In some embodiments, the SUT Accounting Engine 210 consolidates the confirmed and reconciled SUT data, and transmits it to a contracted, third party database that relevant stakeholders 210k, 211a can securely access. In some embodiments, the SUT accounting engine 210 can transmit this confirmed and reconciled SUT data directly to said stakeholders 210k, 211a. In some embodiments, the data is immediately available for general accounting and for generating a diverse spectrum of desired reports, such as, but not limited to, immediate feedback on economic sector performance, account balances, budgeting and budget forecasting, etc.

In some embodiments, the IOR engine 200 caches relevant approved transaction shopping basket data, and waits for transaction finalization confirmation from EFT confirmation 208b. In some embodiments, once confirmed, the IOR accounting engine 211 prepares and forwards the relevant program accounting data to the respective funding source 211a, whether private sector or government program.

For private sector IOR, in some embodiments, the full spectrum of available transaction data and account funds balance are immediately available according to pre-negotiated protocols. For example, in some embodiments, when the source is a parent funding a debit card for their teenager, the full spectrum of available transaction data and account funds balance are immediately available, according to pre-negotiated protocols between source (i.e., the parent) and the beneficiary (i.e., the teenager). In some embodiments, such data could include whether restricted parameters were initially broached before an approved transaction finalized, such as the previous example of trying to buy alcohol in Las Vegas at 2:00 a.m. In some embodiments, relevant transaction data is then available for a wide variety of reports and accounting.

Some embodiments of the invention enabled by the system and methods of the POS management system 10 that encompass government programs can include relevant item and ontology data that is forwarded to the appropriate program database. In some embodiments, the transaction data can be transmitted directly into accounting programs. In some embodiments, the data is immediately available for generating a diverse spectrum of desired reports. In some embodiments, government programs have data privacy issues above and beyond those in the private sector. In some embodiments, the system and methods of the POS management system 10 can be capable of complying with such data privacy restrictions through industry standards and methods commonly known to those skilled in the art.

In some embodiments, to be able to identify item ontology requires a detailed set of item attributes. For example, at least one non-limiting embodiments can comprise an ARTS® POS retail technology for communicating with the ontology engine, and there are two ARTS® schemas that are the primary actors, including, but limited to the ARTS® Item Maintenance Standard and the ARTS® Product Content Management Standard. In some embodiments, they are parallel schemas, and the item schema contains several hundred attributes describing the item details, size, color, etc. In some embodiments, this can also include item hierarchy and category identifiers, as the item maintenance schema includes merchandise hierarchies.

In some embodiments, following a connection of the IOR engine 200 to a store camera system, the ARTS® Video Analytics Standard can be used to convert a digital image into meta-data to identify an item. For example, in some embodiments, the systems and methods of the POS management system 10 can identify items and ontology via images (such as photographs and still images and/or video images) using a video analysis engine 800. In some embodiments, the Product Content Management Schema can contain images about the item. In some embodiments, together they provide a detailed description of an item that can be used by the IOR engine to identify specific items either by site or by detail. In some embodiments, this can be done on two different levels, by either the image being posted as a product content management image and sent to the ontology engine. Or, in some embodiments, the item data can be identified, and the appropriate item information can be transmitted to the ontology engine.

In some embodiments, when the data query gets to the IOR engine 200, the IOR engine 200 needs a detailed data model containing these item attributes in order to do an expedient, powerful search. In some embodiments, the ARTS® data model can provide support for this level of information. Some embodiments of the invention can enable identification of items without being limited to shared, health care UPCs, or needing the merchant to share proprietary inventory codes.

Some embodiments of the system and methods of the POS management system 10 can provide item-level data of buying behavior for analysis of patterns, trends etc. In some embodiments, this can be of great value to retailers, economists and others. In some embodiments, this information can be made available within strictly understood legal parameters, including but not limited to protecting the privacy of individuals and specific merchant identities, as well as protecting specific merchant business concerns, such as, but not limited to, marketing strategies.

FIGS. 2A-2C illustrate portions of a flow diagram 11 showing system integration links and connectivity between various alternative processes across system modules in the POS management system 10 according to another embodiment of the invention. For example, in some embodiments, the POS management system 10 can comprise the systems and methods depicted by the flow diagram 11 showing system integration links and connectivity between various alternative processes across system modules in the POS management system 10. As described earlier, in some embodiments of the invention, the transaction process can begin at the POS where the POS 100 includes a physical retail transaction comprising a POS 100a (i.e., a face-to-face retail transaction), and with the scanning of items in the scan items 102 and from the item file 103 (shown in FIGS. 1A-1C), and with the associated system and methods of the POS management system 10. In some further embodiments, the POS can occur online. In this instance, the POS management system 10 can comprise the systems and methods depicted by the flow diagram 11, where the POS 100 comprises an online transaction comprising a POS 100b, where an online customer can select one or more items and place in a customer cart 101a (i.e. a virtual online shopping cart). Further, in some embodiments, the item file 103 can include an item and price database 103a to enable the POS management system 10 to access item and/or price information. For example, in some embodiments, the POS management system 10 that is initiated with an online transaction (the POS management system 10 can comprise the systems and methods depicted by the flow diagram 11) can include the same recognition, extraction, transmission, identification analysis, restriction list matching, tax calculations, SUT data preparations for both EFT and non-EFT transactions, and all other functions performed by the POS management system 10 as depicted in FIGS. 1A-1C can be used by the POS management system 10 except for differences shown in FIGS. 2A-2C and described below.

In some embodiments, the IOR process illustrated by the flowchart 11 (used to identify item identification and ontology for both restriction applications and for SUT analysis) can function as illustrated in FIGS. 1A-1C, however there is no EFT mechanism pre-swipe (101). Therefore, in some embodiments, the IOR protocols are initiated as customer submits card 104a. In some embodiments, for online purchases, it is essential to identify the buyer's geographical location as it relates to applicable SUT, including, but not limited to, state, county and municipality. In some embodiments, this geographical data can be gleaned during the checkout process. In some embodiments, the customer can add their billing address in customer submits card 104a. In some embodiments, this address becomes part of the transaction log (such as POSLog) data and is transmitted to tax engine 400 via the TM 107. In some embodiments, this can enable the tax engine 400 to identify the proper tax jurisdiction to calculate the proper taxes. Further, in some embodiments, the customer submits card 104a step can be followed by a subtotal transaction 106.

In some embodiments, the inventory identifiers for online merchants are available online, and thus can facilitate item and ontology identification.

In some embodiments, the online merchant can send item and ontology identifications directly to the IOR, further facilitating the various embodiments of the invention.

In some embodiments, where the merchant POS often performs SUT calculations internally, the online embodiments (depicted by the flowchart 11 in FIGS. 2A-2C) can employ third party SUT contractors, such as, but not limited to, Vertex or Avalara. In some embodiments, such third party contractors have complete SUT databases for all taxing jurisdictions throughout the U.S., fully maintained and current, specifically designed for such online applications. For such cases where third party SUT contractors are employed, the SUT calculations are returned to the POS 100 via tax message 402 such as the ARTS® Transaction Tax Standard.

In some embodiments, latency concerns are not as critical an issue for online purchases as they are for in-store purchases, where people are waiting in line at the register.

In some embodiments, online purchases and many sales channels, such as mobile applications, are virtually entirely tendered by EFTs, including, but not limited to, credit cards, debit cards, smart cards, EBT cards, or any type of payment that uses EFTs. In some embodiments, this can simplify the work of the SUT process as it is limited to reconciling EFT transfers. Further, in some embodiments, balancing SUT for solely EFT transfers can use either or both EFT SUT solutions in combination, EFT SUT balancing and SUT bank, described by some embodiments of the invention. Therefore, where FIGS. 1A-1C comprises POS steps 110 and 111, both dealing with non-EFT tendered transactions, the embodiment of the POS management system 10 illustrated by the flowchart 11 does not need to reckon with non-EFT tenders, and hence those POS steps 110 and 111 are no longer necessary (and therefore are absent from the flowchart 11 shown in FIGS. 2A-2C).

Further, whereas the POS management system 10 including processes shown in FIGS. 1A-1C and FIGS. 2A-2C comprise POS step 109 delivering totaled transaction data 207a to the SUT engine 206, in the embodiments shown in FIGS. 1A-1C, the SUT engine 206 recognizes non-EFT tenders, and enacts those processes. Further, the SUT engine 206 depicted in the embodiment of the POS management system in flowchart 11 of FIGS. 2A-2C does not need to recognize non-EFT tenders or enact non-EFT SUT processes.

In some embodiments, major government programs such as Medicare and Medicaid will increase use of online purchasing, where the present invention can perform both IOR and SUT applications as described herein.

Some embodiments of the invention enabled by the system and methods of the POS management system 10 that encompass the IOR engine 200 executing one or more protocols based at least in part on what can or cannot be bought with source funds. In some embodiments, the IOR engine 200 can oversee processes that identify the beneficiary customer and the applicable program, and can oversee processes for the identification of the items and/or ontologies of the items in the proposed shopping basket. Further, in some embodiments, the IOR engine 200 can then compare the applicable program's restriction/approval list to the shopping basket. Further, in some embodiments, the IOR engine 200 can then render a judgment on whether the items in the proposed shopping basket meet source's program specifications. That judgment can be, but is not limited to, approving, denying, or allowing the modification of said basket.

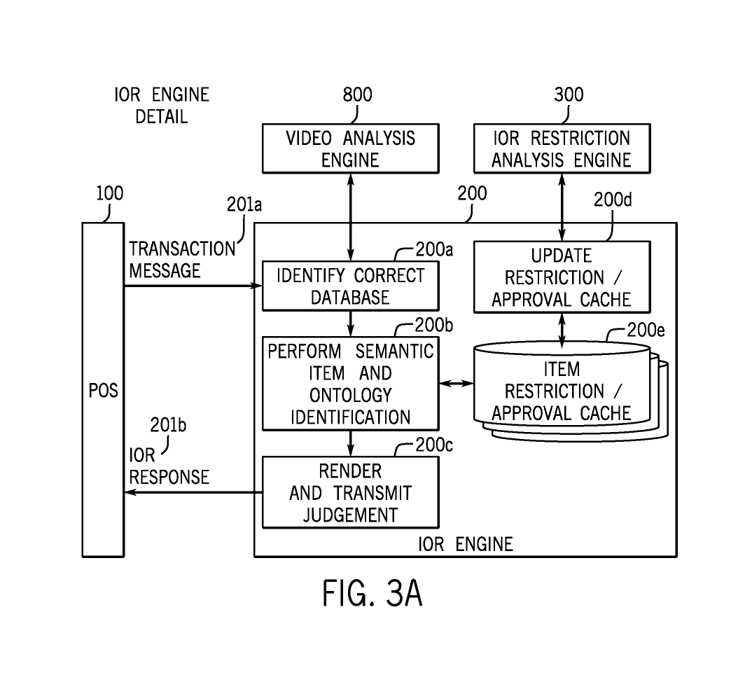

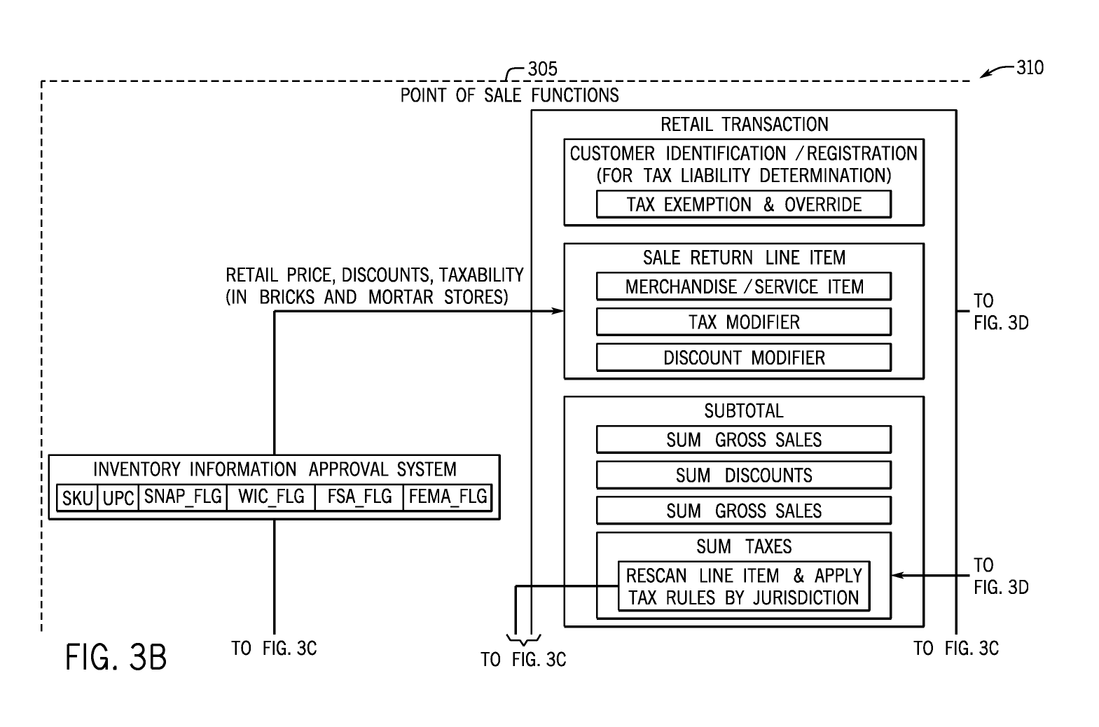

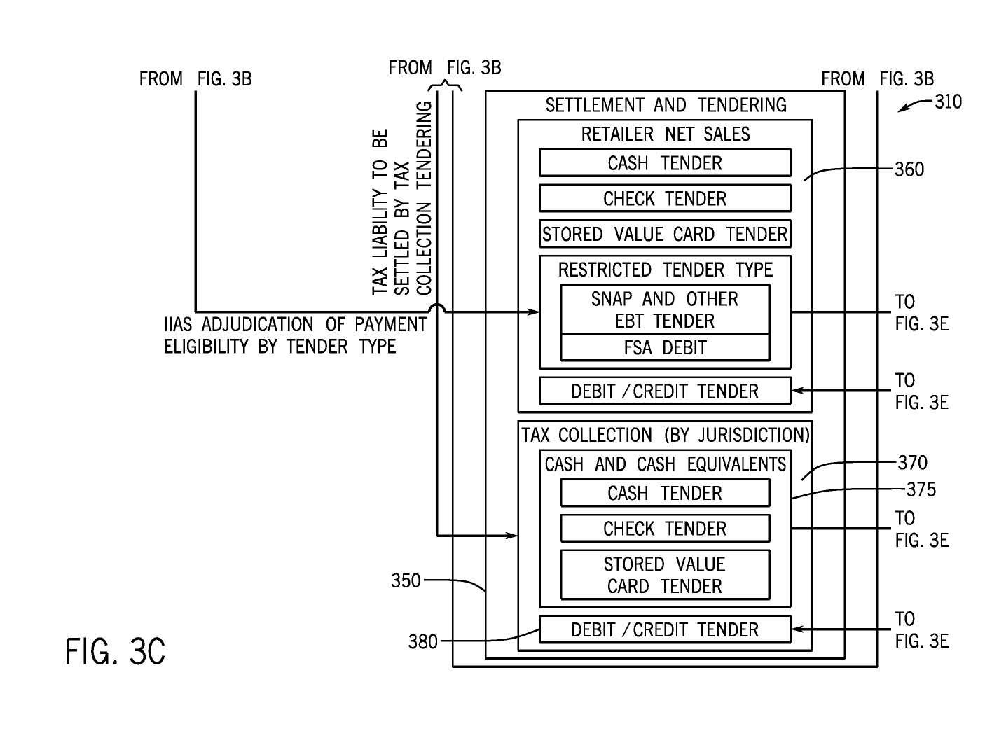

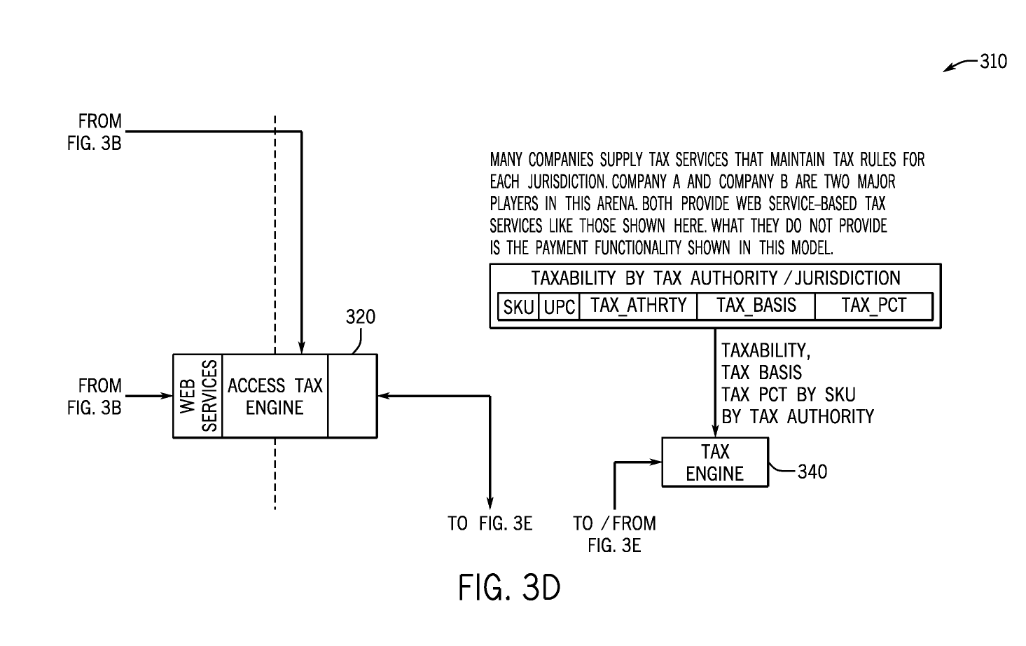

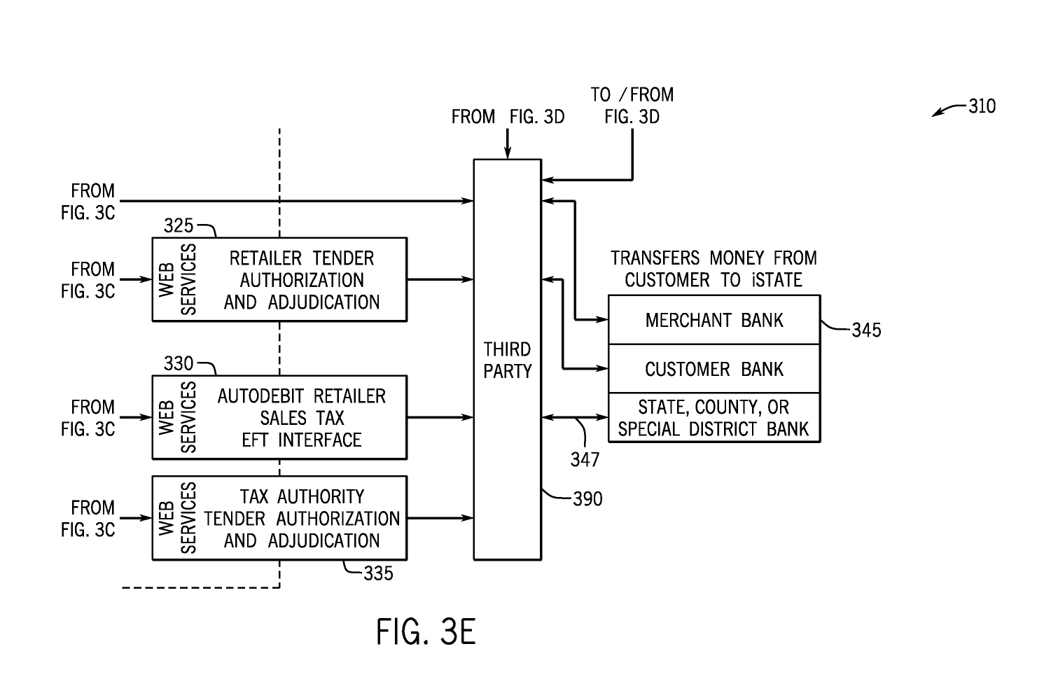

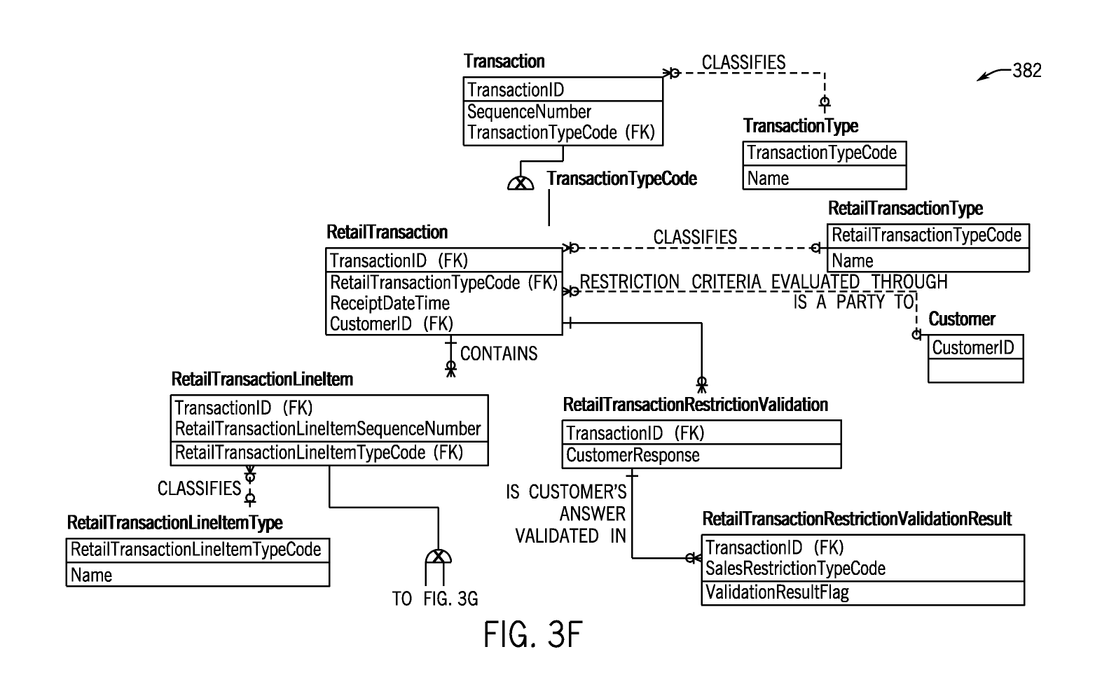

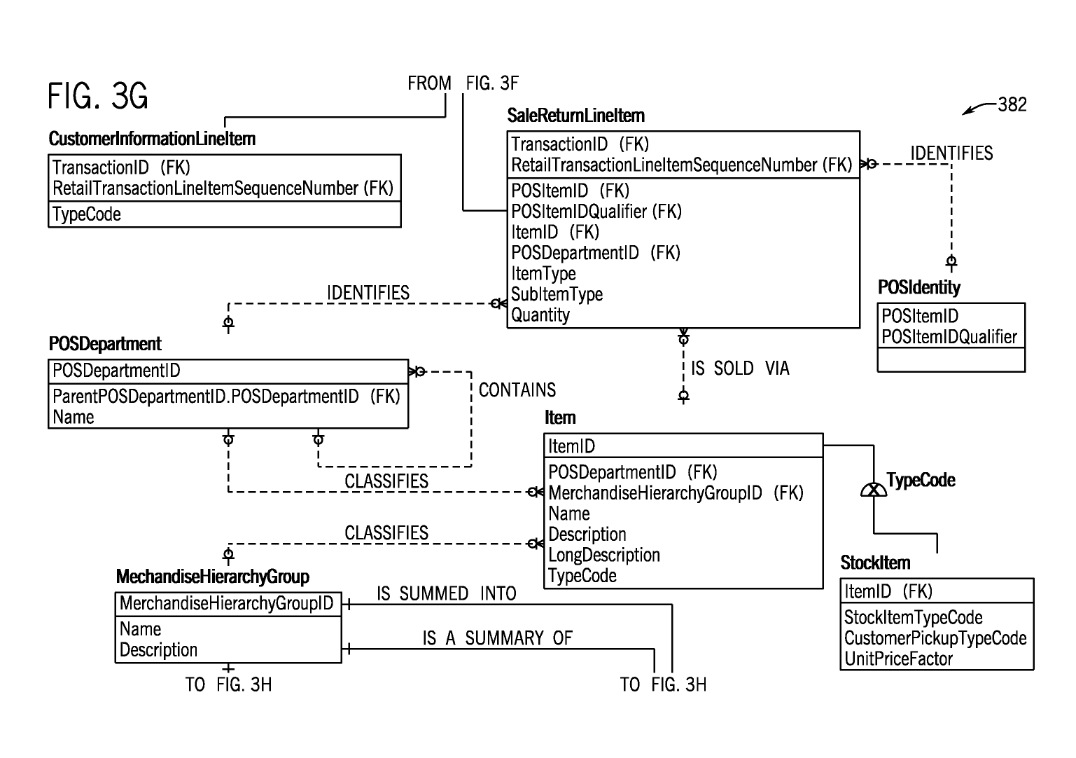

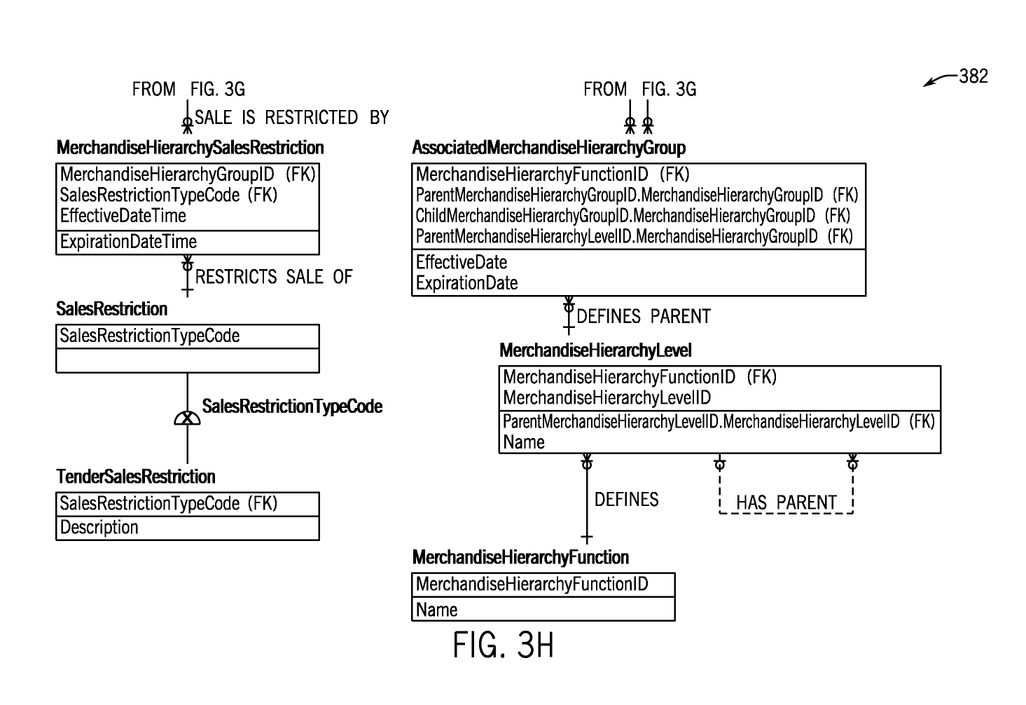

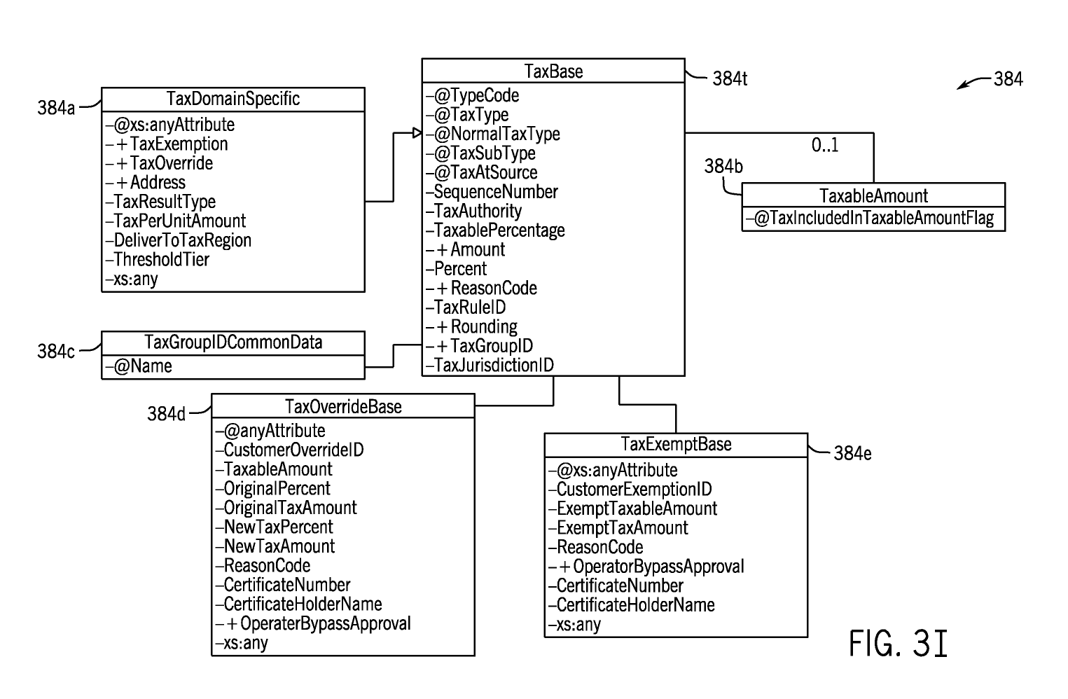

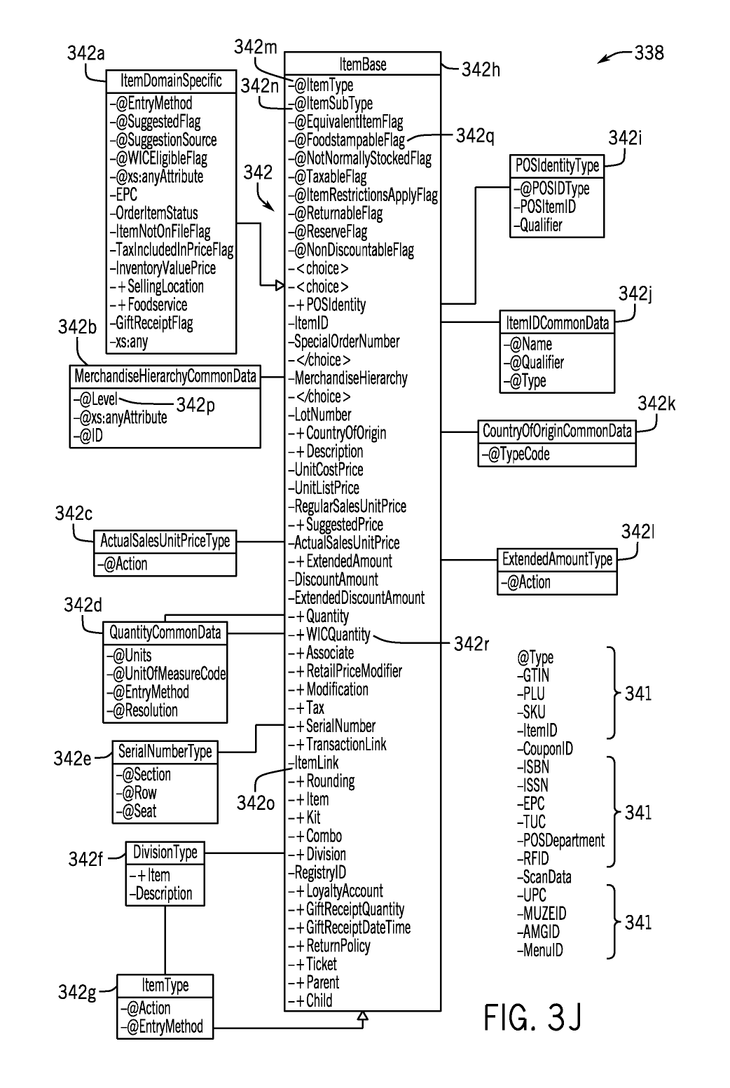

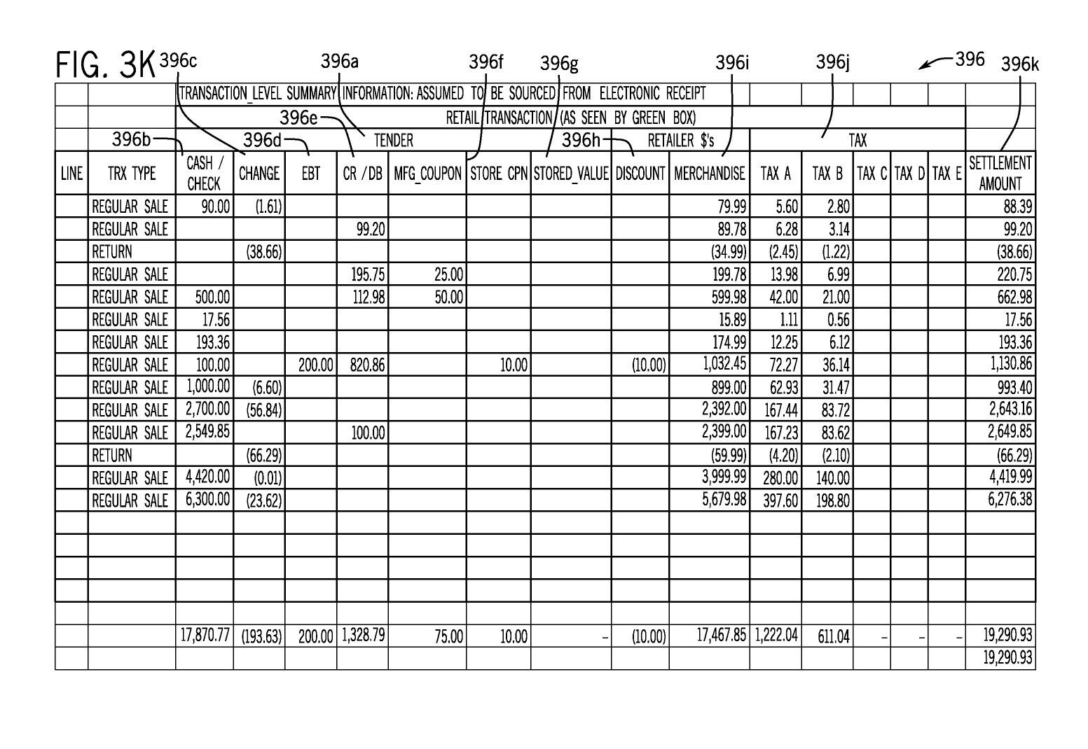

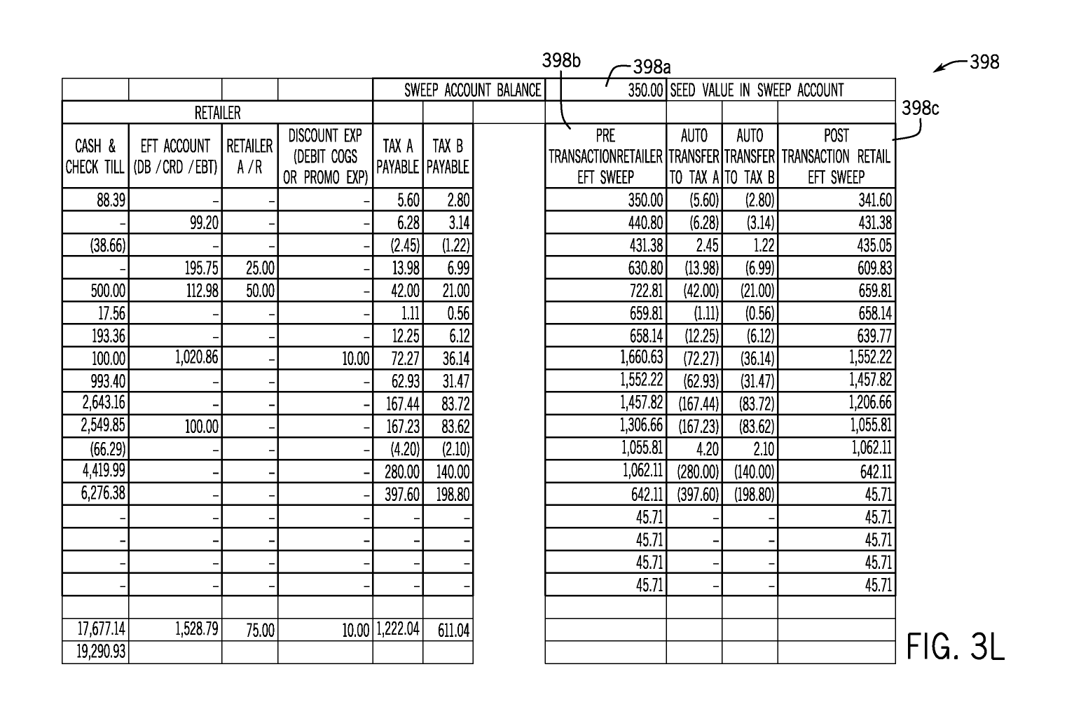

It is important to understand that the system and methods of the POS management system 10 that encompass the IOR engine 200 described herein to execute the full scope of IOR embodiments can vary. Further, in some embodiments, functionality can overlap between the APIs, various engines, the POS, and other instances can occur. The IOR Engine 200 processes as described herein are not meant to limit in any way the core functions of the system and methods of the POS management system 10 to the specific technologies or to configurations as shown. For example, as shown in FIG. 3A, which illustrates IOR engine detail according to some embodiments of the invention, in some embodiments, the IOR restriction analysis engine 300 can maintain and update the item restriction/approval cache 200e in the IOR engine 200 (step 200d). Further, in some other embodiments, the IOR restriction analysis engine 300 can maintain all such databases, and can perform all subsequent data analysis and subsequent database matching, returning the finalized IOR judgment for the IOR engine 200 to transmit to the appropriate merchant.

In some embodiments, the IOR engine 200 can execute one or more of the processes internally, or at times querying third party contractors to execute distinct aspects of the processes (as represented by IOR restriction analysis engine 300 illustrated in FIGS. 1A-1C). In some embodiments, the third-party contractors can include, but are not limited to, large scale data management companies such as SAS® or IBM®, or identification services such as Dynamite Data.

In some embodiments, the IOR engine 200 can execute in three basic steps comprising identify correct database 200a, perform semantic item and ontology identification 200b, and render and transmit judgment 200c.

In some embodiments of the invention, the identify correct database 200a receives transaction message 201a which carries both the transaction message and first identifiers, including, but not limited to, the identity of the merchant, the beneficiary customer and the respective program. The respective program can for example include, but not limited to, government programs such as student loans, Medicare, WIC, SNAP, or private sector programs such as Red Cross, so called “teen cards” or a health insurance FSA.

In some embodiments, identify correct database 200a can identify the applicable database and can send the beneficiary customer identification to said database. This database can be, for example, but not limited to, government programs such as student loans, Medicare, WIC, SNAP, or private sector programs such as Red Cross, so called “teen cards,” or a health insurance FSA.

In some embodiments, an EFT device pre-swipe can send first identifiers to identify the correct database 200a prior to the transmission of items comprising the proposed shopping basket. This procedure can allow identify correct database 200a to cue both the appropriate program database, and the specific beneficiary customer account prior to receiving the transaction message 201a. In some embodiments, the EFT devices include, but are not limited to, credit or debit cards, EBT cards, Google Wallet™, Apple Pay™, smart cards or any such payment device which triggers an EFT.

In some embodiments of the invention, the POS management system 10 can perform a series of analytics to identify specific item identity and ontology. In some embodiments, multiple iterations are performed in parallel, at times integrating specified cache models, and cross-referencing available data. Some embodiments can include data that comprises first identifier information, such as, but not limited to: customer name, customer ID, merchant name, merchant ID, location, time of day, relevant program such as WIC, Medicare, and student loans, etc. Some embodiments can include data that comprises retail schema transaction message information, which includes, but is not limited to: import-export codes, Radio Frequency Identification (“RFID”), Quick Response Codes (“QR”), Global Service Relation Number (“GSRN”), Global Trade Identification Numbers (“GTIN”), European Article Numbering (“EANs”), UPC's, International Standard Book Number (“ISBN”), Universal Service Code (“USC”), coupon ID, Muze ID, POS department codes, International Standard Serial Number (“ISSN”), and other such identifiers. Some embodiments include multiple iteration queries that can comprise commercially available GS1 proprietary lists, publicly available inventory systems, publicly available Google taxonomy category information, publicly available yellow page phone identifiers, researched and collected inventory system identifiers from different merchandisers, inventory systems shared with the ACS, and other such sources. Some embodiments can include other date available for algorithmic cross-referencing and cache modeling.

In some embodiments, the POS management system 10 can maintain either collected, or through negotiated agreement with merchant, the merchant's proprietary inventory identification systems to enable item and ontology identification. Such lists can be held in, for example, but not limited to, the item restriction/approval cache 200e or third-party data management companies represented by the IOR restriction analysis engine 300.

In some embodiments, the transaction log data includes the Name Field. Though computers are presently not capable of understanding language per se, such as the meaning of “pencil”, the word “pencil” is comprised of a series of symbols that can be recognized and matched within a standardized format. So even if the POS management system 10 does not “know” what a “pencil” is, the matching of these symbols to confirm an item in the IOR database is an additional identification tool.

In some embodiments, perform semantic item and ontology identification 200b (either interconnected through identify correct database 200a as shown, or directly) can access video analysis engine 800 to identify item and ontology. In some embodiments, TM 201a can contain images connected to the merchant camera system. Then, for example but not limited to, the ARTS® Video Analytics Standard can be used to convert a digital image into meta-data to identify an item. That is to say that, in some embodiments, the POS management system 10 can identify items and ontology via images, for example, but not limited to, photographs or videos. In some embodiments, the product content management schema contains images about the item. Together they provide a detailed description of an item that can be used by the aforementioned perform semantic item and ontology identification 200b to identify specific items either by site or by detail. Further, in some embodiments, this can be done on two different levels. First, in some embodiments, either the image can be posted as a product content management image and sent to the ontology engine, or second, in some embodiments, the item data can be identified and the appropriate item information can be transmitted to the ontology engine.

In some embodiments, this same video and/or image identification process can be utilized with online purchases, as online services can contain available images.

In some embodiments, the entire IOR process described herein, including identifying the specific beneficiary customer and applicable program database, matching those to the relevant program specifications, the item and ontology identification processes, the subsequent matching said identified items to said program specification, can be executed entirely by third-party data management companies as represented by the IOR restriction analysis engine 300. In some embodiments, the entire process can be executed entirely by perform semantic item and ontology identification 200b, referencing internal servers and databases within the IOR engine 200. Further, in some embodiments, the various processes described above can be performed in tandem by both the IOR restriction analysis engine 300 and perform semantic item and ontology identification 200b, referencing databases and servers within the IOR engine 200.

In some embodiments, additional third parties can be referenced, such as, but not limited to, the video analysis engine 800, or by item identification companies (such as Dynamite Data, LLC, http://www.dynamitedata.com), to perform the processes described. Further, in some embodiment, the perform semantic item and ontology identification 200b can manage and direct the combinations of services and processes so described to arrive at render and transmit judgment 200c.

In some embodiments, after the item and/or its relevant ontology have been identified by perform semantic item and ontology identification 200b, the next step of render and transmit judgment 200c can analyze all the relevant data, the item and ontology identifications, and the applicable program and beneficiary customer restriction/approval lists, and render a decision about the proposed shopping basket of items. In some embodiments, this decision can be, but is not limited to, a judgment to approve, deny or modify by offering to change the proposed shopping basket, which can be, but is not limited to, the beneficiary customer removing the restricted item. In some embodiments, this return judgment can be sent from render and transmit judgment 200c through the IOR response 201b to the POS 100, using either a standardized format, or the same transaction message format it was sent as to be recognizable by the POS 100.

FIGS. 3B-3E each provide a partial view of a POS functional block diagram 310 for sales and use taxes according to one embodiment of the invention, (with a combination of FIGS. 3B-3E providing a view of a POS functional block diagram 310 for sales and use taxes according to one embodiment of the invention). In some embodiments, the POS functional block diagram for sales and use taxes deals specifically with some SUT embodiments of the invention. It focuses on the functionality of the POS system, showing more precisely within the POS transaction process where POS interfaces with a third party 390.

In some embodiments, inside the dotted border 305 represents the POS system functions. In some embodiments, the four boxes sitting on the dotted border 305, access tax services 320, retailer tender authorization and adjudication 325, autodebit retailer sales tax EFT interface 330, and tax authority tender authorization and adjudication 335, all represent API capabilities for transmitting transaction messages between the POS and the third party 390. In some embodiments, synchronous transaction message standards such as POSLog can carry queries from the POS to the third party 390 and return those responses back to the POS.

In some embodiments, matching FIGS. 1A-1B, the “Access Tax Engine” delivers transaction data to the third party 390 from within the “Subtotal” function, with the applicable tax calculations returning to the POS through the third party 390 prior to dealing with the payment splitting. More precisely, the “Access Tax Engine” can intercede the POS process exactly where the POS (prior to the embodiments of the invention described herein) would calculate its own taxes at the “Sum Taxes” subset nested within the “Subtotal” function. In some embodiments, the returning tax calculations from the “Tax Engine” through the third party 390 are inserted back to the precise point within the POS process where they can be readily recognized by the POS and seamlessly inserted into the POS data flow.

In some embodiments, within the settlement and tendering box 350 are the retailer and net sales box 360, and the tax collection (by jurisdiction) box 370. In some embodiments, the retailer and net sales box 360 shows the complexities of tender possibilities (cash, check, stored value cards, restricted EBT cards such as SNAP and FSA cards, debit or credit cards). As shown, in some embodiments, the type of transaction goes from the settlement and tendering box 350 via API to the retailer tender authorization and adjudication box 370, with the transaction total and the taxes owed calculation. In some embodiments, the total tender transaction, merchandise plus tax amounts, is completed here.

In some embodiments, the tax collection (by jurisdiction) box 370 has two nested boxes including the cash and cash equivalents box 375 (for cash or checks), and the debit/credit tender box 380 (for either credit or debit cards). In some embodiments, the credit/debit tender box 380 flows to tax authority tender authorization and adjudication 335 capability. In some embodiments, this informs third party to directly segregate the merchandise transaction total from the tax total, splitting the ACH funds stream per the tax calculations from the previous step (so that the merchant only receives payment for the goods sold) while the tax amount is directed by the third party to the appropriate tax jurisdictions (as illustrated in FIGS. 1A-1B). In some embodiments, the cash & cash equivalents box 375 transmits its data through the autodebit retailer sales tax EFT Interface 330 with its calculations for owed taxes, as there is no ACH funds stream to segregate tax funds from. In some embodiments, the taxes owed calculation from this cash only transaction is stored by the third party 390 to be extracted and balanced from future credit or debit card tender transactions by that same merchant. As shown, in some embodiments, the arrows between the third party 390 and the relevant banks to the right are two-way arrows. Further, there are possible embodiments of invention that include access to each of these banks to return money owed to the customer for returns, to balance up accounts with the merchant, or to return tax money from the state, county, municipal or special tax district banks.

FIG. 3F-3H each provides a partial view of a portion of a data model 382 for transmitting and accessing data according to one embodiment of the invention. The data model 382 is derived from an ARTS® data model, and is shown to illustrate that it is possible to transmit and access relevant, item and ontology data for a variety of applications unique to some embodiments of the invention.

In some embodiments, every time a transaction occurs at the point of sale, the third party 390 must be able to comprehensively save that transaction data to be able to monitor IOR restriction activity, or verify that the proper monies are sent to the correct tax authorities. This means every transaction must be either saved in the third party's database, or forwarded to the appropriate program database. In some embodiments, the data model 382 as illustrated in FIGS. 3F-3H, provides the container for the data so it can be cohesively accessed, transmitted, stored and retrieved as needed. In some embodiments, it also provides precise accessibility to chosen data sets which, according to privacy laws, can need to be destroyed.

FIG. 3I illustrates a POSLog xml schema portion 384 used by the transaction process flow according to one embodiment of the invention, and is a schema detail from the ARTS®® POSLog's Technical Specification V6.0.0. The ARTS® POSLog Technical Specification can be accessed from the Association for Retail Technology Standards (ARTS®), a division of the National Retail Federation, a retailer-driven international membership organization (http://www.nrf-ARTS.org/about). As shown, the POSLog XML schema can include a variety tax information coupled to a tax base 384t, including for example a tax domain specific 384a, a taxable amount 384b, a tax group ID common data 384c, a tax override base 384d, and a tax exempt base 384e, and the detail represents the capacity of transaction messages to ferry complex tax information from the POS to the tax engine and back.

FIG. 3J illustrates a transaction message detail 338 for item identification and ontology according to one embodiment of the invention. FIG. 3J represents a schema detail from the ARTS® POSLog's Domain Model V6.0.0., showing the capacity of transaction messages to carry complex, relevant data. As shown, some embodiments include a variety of linked data types 342, including for example an item domain specific 342a, a merchandise hierarchy common data 342b, an actual sales unit price type 342c, quantity common data 342d, a serial number type 342e, a division type 342f, and an item type 342g. Further, as shown, some embodiments can include a POS identity type 342i, item ID common data 342j, country of origin common data 342k, and extended amount type 342l. Further, some embodiments of the invention claims the capability to identify both item and relevant ontology by interrogating various sources including transaction message data shown in the diagram. Moreover, there are any number of item identifiers in addition to the list 341. In the main “ItemBase” column 342h there is “Item Type” 342m, “ItemSub Type” 342n, and “Item Link” data 342o, all data for item identification. The “MerchandiseHeirarchyCommonData” box 342b upper left contains “Level” data 342p that pertains to category, or ontology. There is other item category information within other ARTS® standards such as the ARTS® Item Maintenance Technical Specification. Transaction message technology continues to migrate towards the uses of some embodiments of the invention with increased item and ontology data. Further, note also the slots in the “ItemBase” column 342h for flagging items for SNAP programs (“FoodstampableFlag”) 342q and for WIC (“WICQuantity”) 342r. At present, these are manually entered into the POS by the merchant. Some embodiments of the invention can relieve the merchant of this ongoing responsibility by accessing current program databases through the third party 390.

FIGS. 3K-3L illustrate a table of transaction level summary information (formed from table portion 396 in FIG. 3K and table portion 398 in FIG. 3L) according to one embodiment of the invention. As shown, the transaction level summary can include at least one variable related to a retail transaction. Some embodiments for example include transactional data related to tender 396a, including a cash/check amount 396b for a specific transaction type, calculated change 396c, EBT 396d, CR/DB 396e, an applied coupon 396f (e.g., a manufacturers coupon or store coupon), and a stored value. The transaction level summary can include a retailer discount 396h and the merchandise cost 396i. The transaction level summary can also include at least one tax amount 396j calculated for each transaction, including a tax A and a tax B for example. The transaction level summary can include the settlement amount.

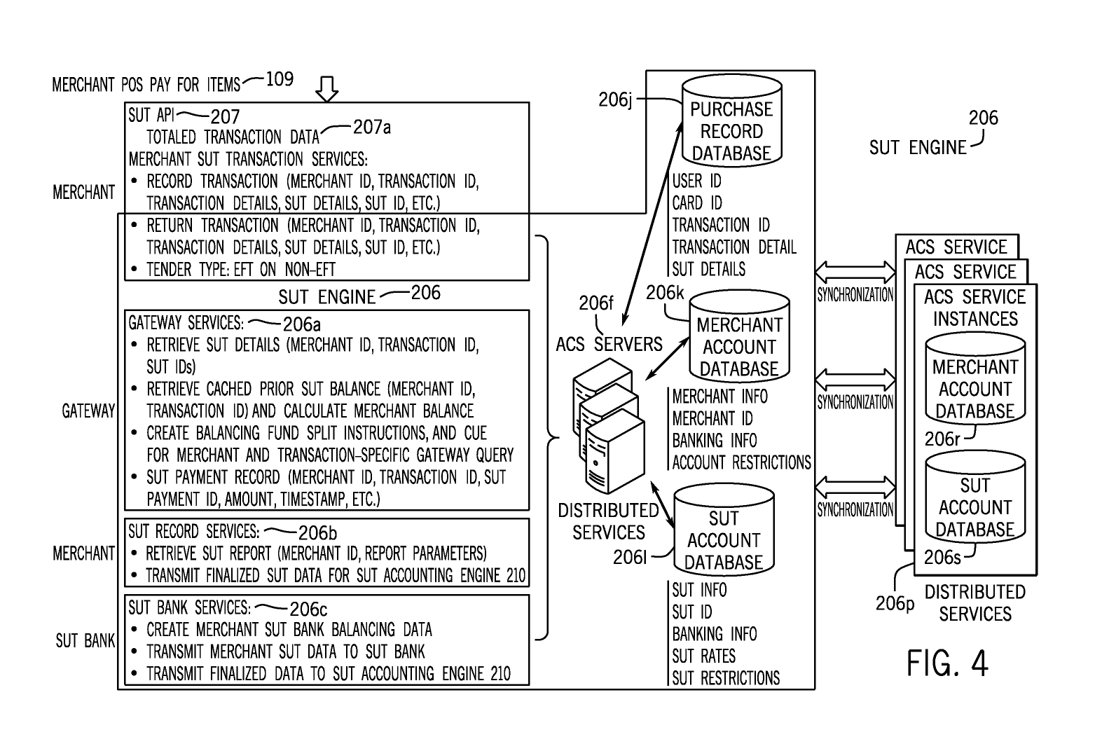

In some embodiments, one or more of the variables related to a retail transaction can be used by the transaction process flow shown in FIGS. 1A-1B as described by the various system and methods as described earlier. As shown in FIG. 3L, some embodiments can include a sweep account 398a in order for a retailer to handle cash sales. In some embodiments, a retailer that deals with cash sales can subsidize a sweep account to keep a positive balance to meet tax jurisdiction's automatic funds transfer requirements on a transaction by transaction basis in near real-time. For example, as shown in FIG. 3L, in some embodiments, a retailer EFT sweep account is added to be CR/DB and EBT tenders. Further, the retailers EFT sweep account is subtracted from when the tax jurisdictions require real-time payment of taxes on a transaction by transaction basis. In some embodiments, the retailers EFT sweep account serves as a cash reservoir that is tapped to make a good EFT request from a tax A and tax B. As shown, the pre-transaction retailer EFT sweep 398b can be calculated as a post transaction EFT sweep balance 398c (from prior transactions) plus the EFT tender. FIG. 4 details the functions and processes of the SUT engine 206, including, but not limited to, its messaging, identifying, account managing, calculating, database maintenance, storage and retrieval, synchronizations and accountings. In some embodiments, the functionality overlaps between various APIs, servers, and databases, and the SUT engine process as described herein is not meant to limit in any way the core functions of this engine to the specific technologies or configurations as shown. In some embodiments, the SUT engine 206 takes in the totaled transaction data 207a from the SUT API 207, and creates and then sends out two types of SUT balancing data. In some embodiments of the invention, for all gateway/acquirer fund splitting processes, the SUT engine 206 creates fund splitting instructions and responds to the gateway's merchant and transaction specific query. In some embodiments, for all SUT bank applications, it creates SUT balancing data and sends that merchant and transaction specific data to the appropriate SUT bank solution. Finally, in some embodiments, the SUT engine 206 sends a confirmed merchant and transaction specific report to SUT accounting engine 210.

In some embodiments, the SUT API 207 sits on the border between the merchant POS pay for items 109 and SUT engine 206. In some embodiments, the SUT Engine 206 comprises a series of servers 206f that in some embodiments, can reference the multiple databases and ACS service instances 206p. In some embodiments, the multiple databases and ACS service instances 206p recognize and segregate relevant transaction data such as merchant ID, transaction ID, and type of transaction, such as item purchase, item return, tax-exempt buyer, etc., and, critically, tender type, whether EFT or non-EFT.

In some embodiments, the servers 206f and ACS service instances 206p can function as a set of highly available, load balanced, distributed services, similar to Apache's Cassandra or Apache's CouchDB. In such an implementation, the underlying architecture is designed to accommodate server overload detection, load balancing, unavailability of a network path, and even automated failover in case of a disaster. In some embodiments, the service can accommodate seasonal surges in demand in order to provide a highly available service providing consistent and continual service response.

In some embodiments, the servers 206f can segregate relevant data from SUT API 207a by both referencing and maintaining various databases through multiple iterations and processes between various servers. For example, in some embodiments, the servers can include the ACS servers 206f, purchase record database 206j, merchant account database 206k, SUT account database 206l, and ACS service instances 206p. In some embodiments, the ACS service instances 206p can include the merchant account database 206r, and the SUT account database 206s. Subsequently, in some embodiments, the servers 206f can create a plurality of services comprising gateway services 206a, merchant services 206b, and SUT bank services 206c.

In some embodiments of the invention, the gateway services 206a can perform various services including retrieving SUT details and querying for merchant-specific prior transaction SUT balances (whether debits or credits), that can be for example created by non-EFT transactions and item return credits, calculating the merchant SUT balance that needs rectifying through current EFT transaction fund splitting, and creating the fund splitting instructions to await gateway query. In some embodiments, the SUT engine 206 accomplishes this through multiple iterations and processes, including, but not limited to, between ACS servers 206f, purchase record database 206j, merchant account database 206k, SUT account database 206l ACS service instances 206p, including merchant account database 206r and SUT account database 206s. In some embodiments, the gateway can anticipate and accept said merchant and transaction specific fund splitting instructions from the SUT engine 206, eliminating the need for said gateway query.

In some embodiments of the invention, the SUT engine 206 can perform at least one function comprising creating SUT service records for specific merchants, and making the records available to the respective merchant. In some embodiments, the SUT engine 206 can accomplish this through multiple iterations and processes between ACS servers 206f, purchase record database 206j, merchant account database 206k, SUT account database 206l, and ACS service instances 206p (including merchant account database 206r and SUT account database 206s). In some embodiments, through the same interactions just described, merchant services 206b can transmit the confirmed SUT data to the SUT accounting engine 210, where, following login security protocols, the respective merchant can access their SUT records.

In some embodiments of the invention, the SUT bank services 206c can perform at least one function including, but are not limited to, retrieving SUT details, querying for merchant-specific prior transaction SUT balances (whether debits or credits that are created by, for example, but not limited to, non-EFT transactions and item return credits), calculating the current merchant SUT balance that needs rectifying, and creating the SUT balancing data to transmit to the appropriate instance of SUT bank 703. In some embodiments, the SUT engine 206 can accomplish this through multiple iterations and processes, including, but are not limited to, between ACS servers 206f, purchase record database 206j, merchant account database 206k, SUT account database 206l, and ACS service instance 206p (including merchant account database 206r and SUT account database 206s). In some embodiments, through the same interactions just described, SUT bank services 206c transmits the confirmed SUT data to the SUT accounting engine 210, where, following login security protocols, relevant SUT authority stakeholders, for example but not limited to, state DOR, relevant municipal or county governments, can access their SUT records.

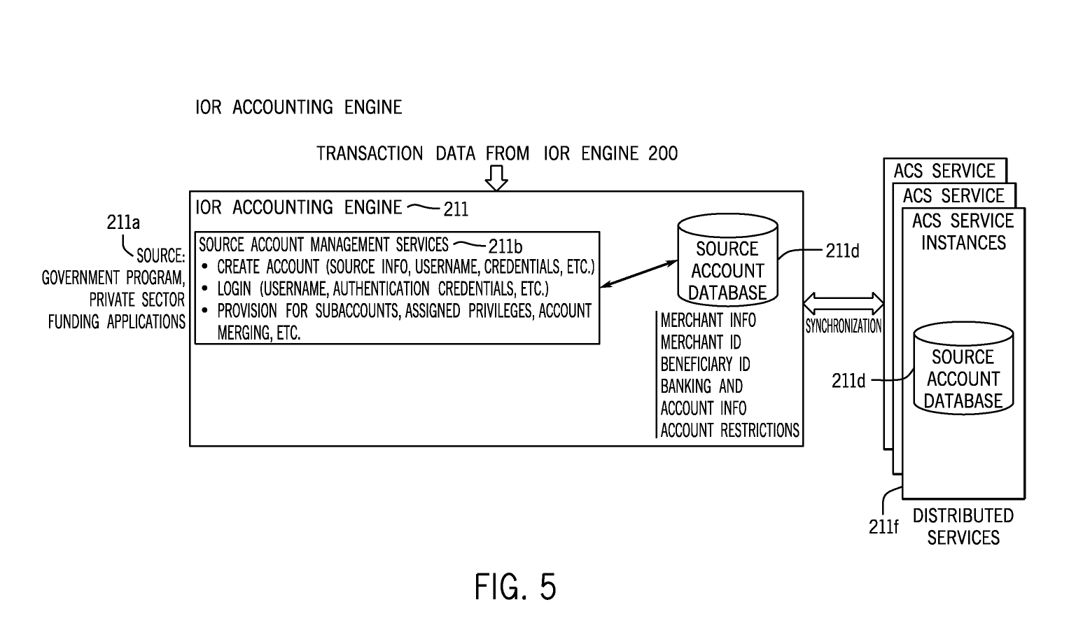

FIG. 5 illustrates IOR accounting engine 211 details according to some embodiments of the invention. In some embodiments, the IOR accounting engine 211 can receive the relevant transaction data directly from the IOR engine 200, and immediately make it available to the funding source 211a. In some embodiments, IOR accounting engine 211 can perform the operations described herein on two basic types of data, comprising financial data on source funds expenditures, and item and ontology data. In some embodiments, both sets of data are transmitted directly by the IOR engine 200 immediately upon transaction confirmation from the POS. Further, the IOR accounting engine 211 sorts and transmits these two data sets to the relevant funding source program accounts immediately upon receiving said data from the IOR engine 200. This completes the comprehensive system and method of the present invention. The financial data keeps relevant program accounting maintained and current. Item and ontology data confirms precisely what was bought with source funds from the funding source 211a. Throughout, both financial and item/ontology data remain in standardized formats, therefore recognizable and useable by both program financial services and item and ontology databases.

In some embodiments, for private sector applications, such as parents funding a teenager's debit card, in addition to having current financial account information, the parents can monitor card activity in near real-time, what items were bought, where and at what time, and what was attempted to be bought.

In some embodiments, for large-scale government programs, the POS management system 10 can maintain financial accounts at near substantially real-time accuracy (whether transmitted directly into program financial accounts such as Intuit®, QuickBooks® or Mint, or to relevant program databases). It will be readily apparent to one skilled in the art the advantages for any government program to have financial accounts automatically updated and current, on an individual beneficiary customer, and individual transaction level if so desired. Intuit®, and QuickBooks® are registered trademarks of Intuit, Inc.

In some embodiments, the IOR accounting engine 211 also tracks item and ontology data on program transactions, and can transmit that data directly into relevant program databases immediately after receiving said transaction data. One skilled in the art would also see the value of immediately accessing item and ontology data on a transaction level basis for generating a full spectrum of program performance reports.

It is important to understand that the technologies and configurations used throughout the systems and methods of the POS management system 10 described herein to execute the full scope of embodiments can vary, and that functionality overlaps between APIs, servers, databases and other instances can occur. In some embodiments, the IOR accounting system and method as described herein is not meant to limit in any way the core functions of the IOR accounting engine 211 to specific technologies and configurations as shown.

Some embodiments of the invention include the use of one or more conventional security technologies and processes. For example, in some embodiments, any method or process of the POS management system 10 can use one or more conventional security technologies and processes. In some embodiments, where legally permissible and desirable by the relevant source program authorities, some of the processes and operations listed herein can be protected within said program authority's own, or contracted, security systems.

In some embodiments of the invention, the IOR accounting engine 211 receives transaction data from the IOR engine 200. In some embodiments, the IOR accounting engine 211 can recognize the relevant program, and transmit that transaction data to the appropriate program database. In some embodiments of the invention, that data can comprise financial data, beneficiary customer ID and item and ontology specific transaction data.

In some embodiments, private sector contracts can be negotiated between source and beneficiary customer, setting parameters on transaction data use, including, but not limited to, privacy issues, beneficiary customer access to transaction data etc.

In some embodiments, if so negotiated, the source can be immediately alerted to the swiping of the beneficiary customer EFT device. Further, in some embodiments, source can be immediately alerted to specific store name and location. Further, in some embodiments, source can be immediately alerted to in some embodiments, the source can monitor transaction progress in real-time.

In some embodiments, the IOR engine 200 can identify relevant programs and segregate the program data, and transmit it to the IOR accounting engine 211. In some embodiments, the ACS contracts these identification and segregation operations to a third-party data management company, including, but not limited to, Oracle or IBM®.

In some embodiments of the invention, the ACS service instances 21 if functions as a set of highly available, load balanced, and distributed services. In such an implementation, the underlying architecture is designed to accommodate server overload detection, load balancing, unavailability of a network path, and automated failover in case of a disaster. Such a service would also need to accommodate seasonal surges in demand. In some embodiments, the service can accommodate seasonal surges in demand in order to provide a highly available service providing consistent and continual service response.

In some embodiments, accounting specific financial data can be transmitted directly into the relevant source accounting program, such as, but not limited to, Intuit® or QuickBooks®, keeping source financial accounts maintained and current.

In some embodiments, and as shown in FIG. 5, accounting specific data can transmitted to source account database 211d, where source can access said data and subsequently perform desired accounting operations.

In some embodiments, the source account management services 211b can provide processes for source or source assigns to access their respective IOR data in a source account database 211d. In some embodiments, once a secure login is established, the source can access its respective IOR data, and/or modify their account. For example, in some embodiments, account modifications can comprise arranging the data in different configurations, making provisions for subaccounts, assigning access privileges, merging accounts, etc. In some embodiments, the source can also download their respective data for further use. For example, in some embodiments, uses can comprise generating desired reports for budgeting, forecasting, item and ontology consumption patterns, etc.

In some embodiments, source account management services 211b can provide processes for source or the source assigns to manage their account, including, but not limited to, accessing and modifying IOR restriction/approval parameters, such as, but not limited to, restricted items and ontologies, approved items and ontologies, etc.

In some embodiments of the invention, the POS management system 10 through the IOR Accounting Engine 211 can function as an anti-fraud tool for government programs, such as Medicare, which suffers approximately $80 billion annually in fraud. Much of this loss derives from fraudulent payment bundling, where millions of dollars in fake expenses are bundled and submitted by sham companies. In some embodiments, by maintaining current and per-transaction data which directly links specific beneficiary customers to specific transactions to specific accounts (complete with both financial data and item/ontology data) the POS management system 10 can enable Medicare to financially monitor individual accounts in real-time. Since this streamlines the accounting system, this eliminates the need for prior streamlining processes such as third-party payment bundling, and hence that source of fraud.

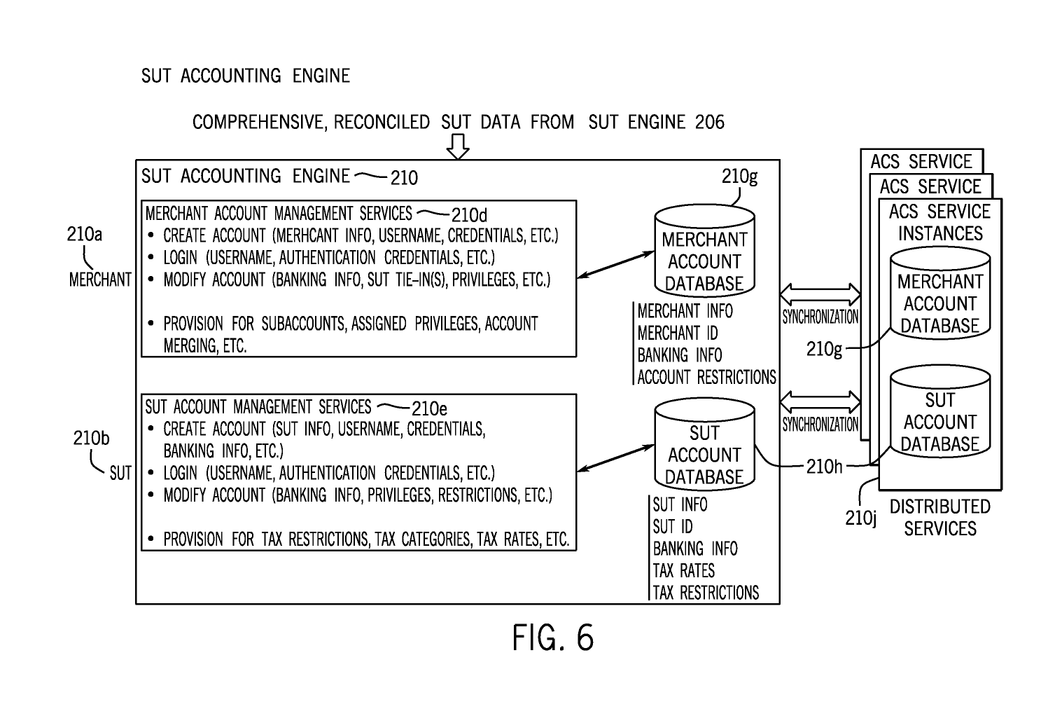

FIG. 6 illustrates SUT accounting engine detail according to one embodiment of the invention. In some embodiments of the invention, SUT accounting can make the relevant data from all iterations of SUT balancing and resolution immediately available to stakeholders, including, but not limited to, tax jurisdictions receiving the revenue such as the state DOR, and municipal and county governments. Other stakeholders include, but are not limited to, the respective merchants, so they can track their SUT payments and balances. One skilled in the art can see the value accessing such current data, on virtually any desired timeline, for budgeting, forecasting, monitoring economic sector performance, generating desired reports, and, for merchants, immediate access to their SUT data and status.

Some embodiments of the invention include the use of one or more conventional security technologies and processes. For example, in some embodiments, any method or process of the POS management system 10 (including the SUT accounting engine) can use one or more conventional security technologies and processes. At times, where legally permissible and desirable by the relevant state authorities, in some embodiments, some of the processes and operations listed herein can be protected within and by the state's own, or state's contracted, security systems.

There are many legal issues surrounding SUT, often differing with each state. Issues such as, but not limited, to SUT calculations, handling SUT funds, creating and handling SUT data, access to state DOR accounts, calculating SUT distributions to various state, municipal and county entities and distributing said funds, issues of merchant responsibility, and many others, raise questions about legally executing said system and method. Some embodiments of the invention do not claim to take into account and comply with all such legal issues.

In some embodiments of the invention, the ACS service instances 210j can function as a set of highly available, load balanced, distributed services. In such an implementation, the underlying architecture is designed to accommodate server overload detection, load balancing, unavailability of a network path, and even automated failover in case of a disaster. Such a service would also need to accommodate seasonal surges in demand. The goal would be to provide a highly available service providing consistent and continual service response.

Referring back to FIG. 4, the SUT engine 206, the SUT record services 206b (for the merchant), and SUT bank services 206c (for the relevant tax authorities) can send their respective reconciled and finalized SUT data to SUT accounting engine 210, and their respective databases comprising the merchant account database 210g and SUT account database 210 H (as shown in FIG. 6).

In some embodiments, the merchant account management services 210d can provide processes for one or more merchants (represented as merchants 210a) to access their respective SUT data (comprising merchant SUT data 210b) in a merchant account database 210g. This includes pathways for merchants 210a to register and create an account, for example but not limited to, websites provided by ACS or the state's DOR. In some embodiments, once a secure login is established, merchants 210a can access their respective merchant SUT data 210b, and modify their account (e.g., arranging said data in different configurations, making provisions for subaccounts, assigning access privileges, merging accounts etc.) In some embodiments, merchants 210a can also download their respective data for further use, for example, but not limited to, generating desired reports.

In some embodiments, the SUT account management services 210e can provide processes for SUT authorities and authorized recipients to access their respective SUT data in SUT account database 210h. In some embodiments, this can include pathways for the appropriate authorities, most notably, but not limited to, the respective state's DOR, to create and register accounts, for example but not limited to, websites provided by ACS or within the website of the respective state's DOR. In some embodiments, once a secure login is established, authorized SUT entities can access their respective SUT data, access and arrange said data in different configurations, make provisions for subaccounts, etc. In some embodiments, these various entities authorized to access their own accounts can assign access privileges to other entities. In some embodiments, the various entities cannot assign access privileges to others, and only the relevant state authority, such as, but not limited to, the state's DOR, can assign access privileges.

In some embodiments, authorized entities can also download their respective data for further use, for example, but not limited to, generating desired reports. One skilled in the art would understand how valuable having immediate access to such data, for example, but not limited to, monitoring economic sector performance, budgeting, budget forecasting, troubleshooting, etc.

In some embodiments, the IOR process as described herein includes having the merchant's transaction-specific log sent through various APIs, to IOR engines and IOR restriction analysis engines (which perform various item and ontology identifications), and then matching those identifiers to restriction/approval lists, and then returning an approve/deny/modify response back through those same channels to the originating POS.

In some embodiments, instead of the IOR engines identifying the item and ontology, the IOR engine 200 (via IOR API 201) can return the said restriction/approval list back to POS 100 in standardized format as to be recognized by the POS 100. In some embodiments, the POS 100 can then (by prior agreement with the merchant) display the restriction list on a POS clerk screen 1000a of a POS machine 1000.

In some embodiments, this restriction/approval list can be relatively short, perhaps ten or so items, to allow for fast and easy recognition by the register clerk working with in-store latency concerns. Such limited approval/restriction lists, in some embodiments, primarily function for private sector applications.

In some embodiments, the pathway back to the POS register screen (i.e., the POS clerk screen 1000a) can be well established using standardized formats, currently used primarily to receive approval/denial messages from the gateway regarding the availability of customer funds for EFT transactions. In some embodiments, this return pathway can be capable of receiving additional messages in standardized formats. In some embodiments, many POS systems support register clerk-specific screens where the clerk can read such messages. Though this screen is maintained and controlled by the POS, in some embodiments it can, by prior agreement with the merchant, display return messages to the register clerk, interfacing with a handshake from IOR API 201 using standardized formats. For example, in some embodiments, if the restriction list was “no alcohol or cigarettes,” when the beneficiary customer swiped their EFT mechanism, it would undergo precisely the same processes as described in the systems and methods of the POS management system 10. However, in some embodiments, instead of returning a decision of approve/deny/modify, the IOR Engine 200 can return the beneficiary customer's restriction/approval list, in this example, “no alcohol or cigarettes.” This of course requires the register clerk to monitor and control the transaction. However, the register clerk already performs such duties for government programs such as, but not limited to, WIC.

In some embodiments, the Restriction/Approval List 220, configured to communicate with the POS 100 and subsequently the POS clerk screen 1000a can be contained within an EFT device. In some embodiments, EFT devices such as smart cards, Google Wallet™, and Apple Pay™, can include memory chips that can carry restriction/approval lists and judgment protocols within the device memory. In some embodiments, these lists can be tamper-protected, and can be securely downloaded onto such devices by a number of methods, such as, but not limited to, source websites, program websites, and/or embedded directly by a source (such as funding source 211a) into the EBT smartcard chip, etc. In some embodiments, restriction/approval lists can therefore be transmitted directly to the POS 100, and modified to accommodate this application, along with payment information at the merchant register (such as the POS 100a, a face to face retail POS transaction). Therefore, in some embodiments, at least a portion of the POS management system 10 including the entire IOR process can occur at this register without engaging any external ACS systems and methods to execute IOR protocols for that specific transaction. In this instance, all of the data necessary to execute the IOR system and method and enact judgment protocols resides within the EFT device and with said device's designed capacity to communicate with the POS. One skilled in the art can appreciate the streamlined nature of executing IOR protocols in this way.

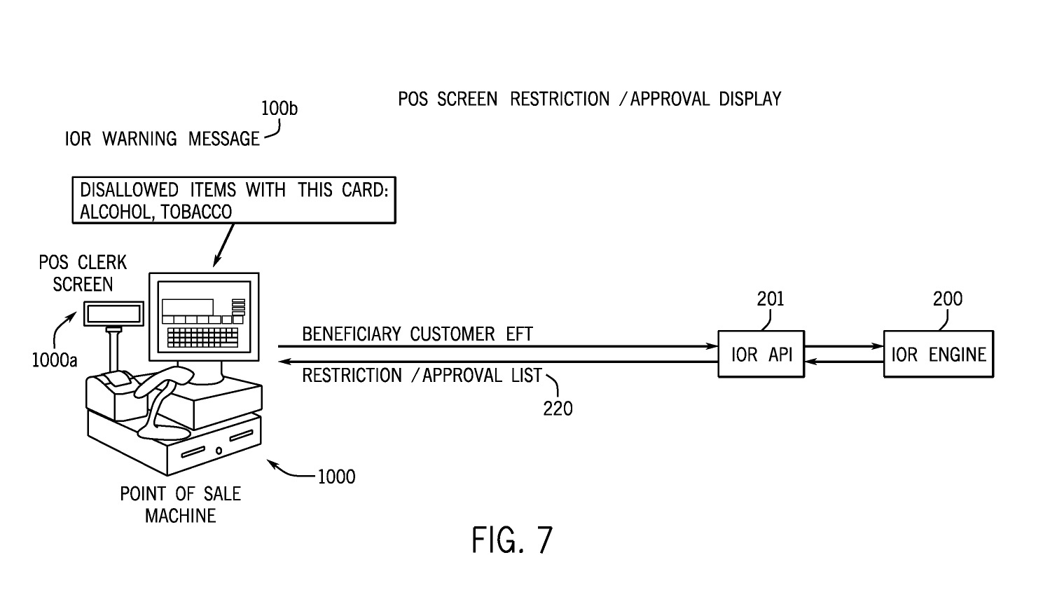

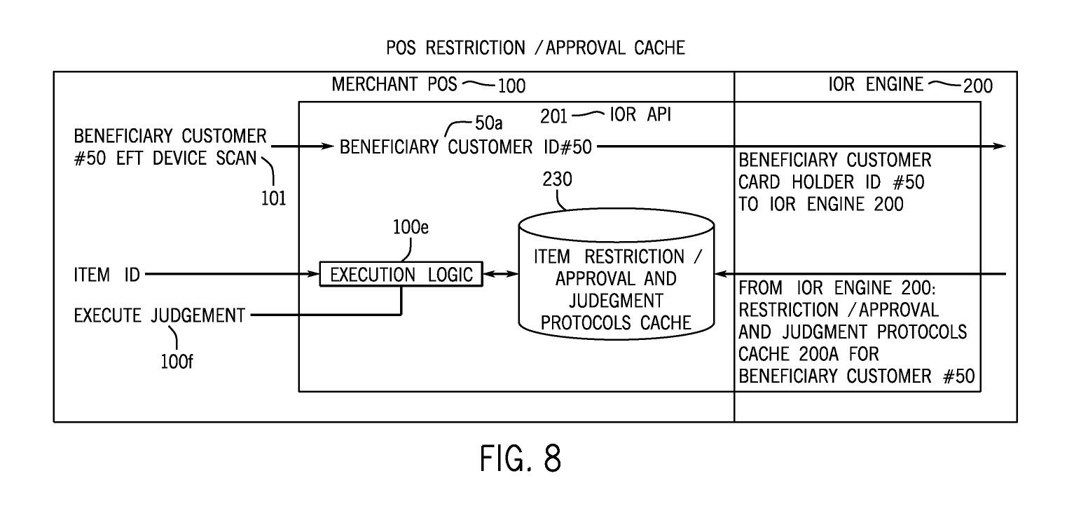

FIG. 7 illustrates a POS screen restriction/approval display and describes the embodiment of returning restriction/approval lists to the POS, specifically to the clerk's display screen 1000a, where the clerk could read said list and subsequently monitor and control the transaction. FIG. 8 illustrates a POS restriction/approval cache according to one embodiment of the invention, and describes a further embodiment where the entire restriction/approval cache and judgment is sent to the POS for recognition and response, engaging internal POS functions to execute judgment protocols. In some embodiments, this process can relieve the clerk from monitoring and oversight responsibilities that can be required of embodiments depicted in FIG. 7, as the POS response is substantially the same as one or more methods described by the embodiments depicted in FIG. 1A-1C, where the POS internally executes judgment protocols. In some embodiments, this cached restriction/approval list can be extensive, including, but not limited to, private sector insurance uses such as FSAs, government programs such as FEMA, SNAP, WIC etc. In some embodiments, these embodiments depend on the POS capacity to recognize items in the restriction/approval cache, match them to their own internal inventory identifiers, and understand the judgment protocols of this specific beneficiary customer's account included with said cache.

In some embodiments, the POS can recognize the cached restriction/approval list due to universalized identifiers, such as, but not limited to, adoption of GS 1 taxonomies.

In some embodiments, the POS can recognize the cached restriction/approval list due to advanced standardized format recognitions, such as, but not limited to, language recognition programs.

In some embodiments, the POS can recognize the cached restriction/approval list due to the merchant sharing proprietary identification systems with the ACS, so that the returned restriction/approval cache is intrinsically recognizable by the POS.

Further, it is important to understand that the technologies used throughout the processes described herein to execute the full scope of embodiments can vary. In some embodiments, functionality can overlaps between APIs, various engines, the POS proper and other instances can occur. In some embodiments, the POS restriction/approval cache process as described herein is not meant to limit in any way the core functions of said process to the specific technologies or configurations as shown.

In some embodiments, the methods depicted by the POS restriction/approval cache of FIG. 8 can begin with the EFT device scan (scan card 101) of a beneficiary customer 50 that can comprise a beneficiary ID. For example, in some embodiments, the beneficiary customer 50 can comprise a beneficiary customer ID of “#50” 50a.

However, in some embodiments, instead of IOR API 201 transmitting the entire transaction message (as depicted in FIG. 1A-1C), only the beneficiary customer's ID (in this example, “#50” 50a) is transmitted. Further, in some embodiments, the IOR Engine 200 can follow substantially the same process as depicted in FIGS. 1A-1C, and can query the IOR restriction analysis engine 300 if necessary. However, none of these item and ontology identification processes are enacted in some embodiments. In some embodiments, the only data queried in this process is beneficiary customer #50's restriction/approval and judgment protocols cache 230 (hereafter referred to as “cache 230”), which is sent via IOR API 201 to the merchant POS 100.

Those skilled in the art will recognize that this represents a less complex series of processes for the entire IOR system. Instead of identifying item and ontology from a given transaction message from an immense database comprising of all known inventory identifiers and operating on those identifiers for those answers, in some embodiments, the IOR system can now identify a single cache for the specific customer beneficiary, and transmits that exponentially smaller restriction/approval list, with those judgment protocols, such as, but not limited to, approve/deny/modify, back to the POS.

In some embodiments, cache 230 operates from within IOR API 201, as shown, as well as the execution logics 100e, and interfaces with the merchant POS 100 as such. As shown, the execute judgment 100f can be sent within the POS (referencing FIGS. 1A-1C) either to scan items 102 if denied or modified, or to the subtotal transaction 106 if approved (as depicted in FIGS. 1A-1C).

In some embodiments, the merchant POS 100 can accept and execute judgment protocols expressed by cache 230, and IOR API 201 delivers said cache directly into the merchant POS 100 through this interface.

In some embodiments, the items and ontologies within cache 230 can be tagged themselves with judgment protocols, and thus can interface directly with the POS 100 for judgment execution. In some embodiments, many POS systems have internal flagging mechanisms, such as for alcohol. In some embodiments, many POS systems have internal hierarchies for restrictions and approvals. In some embodiments, judgment protocols, mutually recognized between POS 100 and IOR engine 200, through various embodiments of the invention can interface and engage directly with the flagging mechanism, and internal hierarchies for execution.

In some embodiments, the cache 230 (configured to communicate with POS 100) can be contained in the EFT device. In some embodiments, the EFT devices can be, but not limited to, smart cards, Google Wallet™, Apple Pay™, carry memory chips, and can therefore carry the restriction/approval cache and judgment protocols within the device memory. In some embodiments, caches (that can be tamper-protected) can be securely downloaded onto such devices by a number of methods, such as, but not limited to, source websites, program websites, embedded directly by source (such as fund source 211a) into the EBT smartcard chip etc. In some embodiments, the cache 230 can therefore be transmitted directly to the POS 100, modified to accommodate this application, along with payment information at the merchant in-store register. Therefore, in some embodiments, the entire IOR process can occur at said register, without engaging any external ACS systems and methods to execute IOR protocols for that specific transaction. In some embodiments, all of the data necessary to execute the IOR system and method and enact judgment protocols can resides within the EFT device and with said device's designed capacity to communicate with the POS 100. One skilled in the art can appreciate the streamlined nature of executing IOR protocols in this way.

Some embodiments of the invention can also relate to a device or an apparatus for performing the various processes and methods as described herein. In some embodiments, the apparatus can be specially constructed for the required purpose, such as a special purpose computer. In some embodiments, when defined as a special purpose computer, the computer can also perform other processing, program execution or routines that are not part of the special purpose, while still being capable of operating for the special purpose. Alternatively, in some other embodiments, the operations can be processed by a general purpose computer selectively activated or configured by one or more computer programs stored in the computer memory, cache, or obtained over a network. Some embodiments include instances when data are obtained over a network, and where the data can be processed by other computers on the network, e.g. a cloud of computing resources.

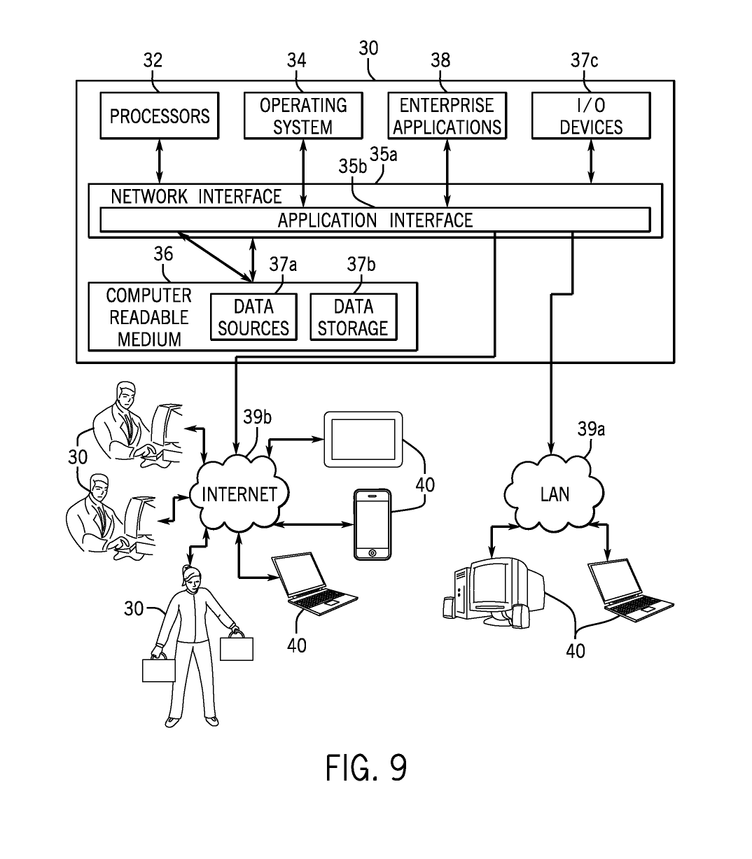

FIG. 9 illustrates one example of a system 30 that can be used by one or more software modules of the POS management system 10 (illustrated in FIGS. 1A-1C) and/or alternative embodiments of the POS management system 10 (comprising the embodiments depicted by the flowchart 11 of FIGS. 2A-2C). For example, in some embodiments, the system 30 can include at least one computing device, including at least one or more processors 32. In some embodiments, some processors 32 can include processors 32 residing in one or more conventional server platforms. In some embodiments, the system 30 can include a network interface 35a and an application interface 35b coupled to at least one processors 32 capable of running at least one operating system 34. Further, the system 30 can include a network interface 35a and an application interface 35b coupled to at least one processor 32 capable of running one or more of the software modules 38 (e.g., one or more enterprise applications). In some embodiments, the software modules 38 can comprise a server-based software platform. In some embodiments, the system 30 can also include at least one computer readable medium 36. In some embodiments, at least one computer readable medium 36 can be coupled to at least one data storage device 37b, and/or at least one data source 37a, and/or at least one input/output device 37c.

In some embodiments, the invention can also be embodied as computer readable code on a computer readable medium 36. In some embodiments, the computer readable medium 36 can be any data storage device that can store data, which can thereafter be read by a computer system. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. In some embodiments, the computer readable medium 36 can also be distributed over a conventional computer network. For example, in some embodiments, the computer readable medium 36 can also be distributed over and/or accessed via the network interface 35a. In this instance, computer readable code can be stored and executed in a distributed fashion using the computer system 30. For example, in some embodiments, one or more components of the system 30 can be tethered to send and/or receive data through a local area network (“LAN”) 39a. In some further embodiments, one or more components of the system 30 can be tethered to send or receive data through an internet 39b (e.g., a wireless internet). In some embodiments, at least one software module 38 running on at least one processor 32 can be configured to be coupled for communication over a network 39a, 39b.

In some embodiments, one or more components of the network 39a, 39b can include one or more resources for data storage and retrieval. This can include any computer readable media in addition to the computer readable media 36, and can be used for facilitating the communication of information from one electronic device to another electronic device. Also, in some embodiments, the network 39a, 39b can include wide area networks (“WAN”), direct connections (e.g., through a universal serial bus port), other forms of computer-readable media 36, or any combination thereof. In some embodiments, the software modules 38 can be configured to send and receive data from a database (e.g., from a computer readable medium 36 including data sources 37a and data storage 37b that can comprise a database). Further, in some embodiments, data can be accessed and received by the software modules 38 from at least one other source.

In some embodiments, one or more components of the network 39a, 39b can include a number of client devices which can be personal computers 40 including for example desktop computers, laptop computers, digital assistants, personal digital assistants, cellular phones, mobile phones, smart phones, pagers, digital tablets, internet appliances, and other processor-based devices. In general, a client device can be any type of external or internal devices such as a mouse, a CD-ROM, DVD, a keyboard, a display, or other input or output devices 37c. In some embodiments, at least one of the software modules 38 can be configured within the system to output data to a user via at least one digital display (e.g., to a computer 40 comprising a digital display). Further, in some embodiments, various other forms of computer-readable media 36 can transmit or carry instructions to a user interface such as a computer 40, including a router, private or public network, or other transmission device or channel, both wired and wireless.

In some embodiments, the system 30 as described can enable one or more users 40 to receive, analyze, input, modify, create and send data to and from the system architecture 30, including to and from one or more software modules 38 running on the system architecture 30. Some embodiments include at least one user 40 accessing one or more modules 10, including at least one software module 38 via a stationary I/O device 37c through a LAN 39a. In some other embodiments, the system 30 can enable at least one user 40 accessing software module 38 via a stationary or mobile I/O device 37c through an internet 39a.

With the above embodiments in mind, it should be understood that some embodiments of the invention can employ various computer-implemented operations involving data stored in computer systems (such as the system 30 shown in FIG. 9). In addition, in some embodiments, the above-described applications of the monitoring system can be stored on computer-readable storage media. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Any of the operations described herein that form part of the invention are useful machine operations. The invention also relates to a device or an apparatus for performing these operations. The embodiments of the invention can be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by one or more processors 32. In such an example, the processors 32 can transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media (such as computer readable medium 36) as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

1. A sales and use tax analysis and reconciling system comprising:
a processor;
a first non-transitory computer-readable storage medium for tangibly storing thereon program logic for execution by the processor, the program logic including at least a portion of a point of sale management system that comprises:
an item and ontology restriction interface executed by the processor and configured to receive point of sale transaction data from a point of sale transaction and process at least one transaction message from the transaction data;
an item and ontology restriction engine executed by the processor for receiving at least one transaction message from the item and ontology restriction interface, the item and ontology restriction engine configured and arranged to receive a transaction message relating to a point of sale transaction; and
wherein the item and ontology restriction engine includes a process for sending the transaction message to an item and ontology restriction analysis engine coupled to a restriction database, and a process for sending a transaction message comprising a transaction judgment item and ontology restriction response through the item and ontology restriction engine from the item and ontology restriction analysis engine;
a sales and use tax application program interface executed by the processor and configured to transmit totaled transaction data;
a sales and use tax engine executed by the processor for receiving the totaled transaction data, the sales and use tax engine configured to create instructions for an acquirer gateway, the instructions comprising fund split instructions and electronic fund transfer instructions;
a sales and use tax accounting engine executed by the processor, the sales and use tax accounting engine including processes for sales and use tax analysis and reconciliation of sales and use tax data, the sales and use tax accounting engine configured to transmit reconciled sales and use tax data to a funding source; and
an item and ontology restriction accounting engine executed by the processor and configured to receive sales and use tax financial data from the sales and use tax accounting engine and transmit sales and use tax accounting data to a funding source.

2. The system of claim 1, wherein the item and ontology restriction engine executed by the processor is configured to send transaction data to the item and ontology restriction accounting engine.

3. The system of claim 1, wherein the item and ontology restriction is coupled to a video analysis engine.

4. The system of claim 1, wherein the sales and use tax engine executed by the processor is configured to send a confirmed merchant and transaction specific report to the sales and use tax accounting engine, the confirmed merchant and transaction specific report comprising merchant and merchant sales and use tax data.

5. The system of claim 1, wherein the sales and use tax engine executed by the processor is configured to prepare an aggregate sales and use tax balance and transmits the sales and use tax balance as sales and use tax bank data accounting data to a sales and use tax bank.

6. A system of claim 1, where the point of sale transaction comprises a physical retail point of sale transaction that includes a scan items step, the scan items step comprising access to an item file database.

7. The system of claim 1, wherein the point of sale transaction comprises an online point of sale transaction, a customer fills cart, and a customer submits card step, the customer fills cart step including access to an item file database comprising at least one item and price file.

8. The system of claim 1, wherein the sales and use tax engine executed by the processor is configured to deliver fund splitting instructions when queried by the acquirer gateway.

9. The system of claim 8, wherein the acquirer gateway executed by the processor is configured to query the sales and use tax engine after receiving instructions from an electronic fund transfer and non-electronic fund transfer decision process.

10. The system of claim 1, wherein the acquirer gateway executed by the processor is configured to transmit at least one fund splitting instruction to an acquirer.
